(19) United States
(12) Patent Application Publication
(10) Pub. No.: US 2025/0021302 A1
(43) Pub. Date: Jan. 16, 2025

(54) GRAPHICS PROCESSORS

(71) Applicant: Arm Limited, Cambridge (GB)

(72) Inventor: Olof Henrik Uhrenholt, Lomma (SE)

(73) Assignee: Arm Limited, Cambridge (GB)

(21) Appl. No.: 18/763,457

(22) Filed: Jul. 3, 2024

(30) Foreign Application Priority Data
Jul. 10, 2023 (GB) 2310537.2

(51) Int. Cl. G06F 7/483; G06F 7/499; G06T 1/20; G06T 15/80

(52) U.S. Cl. CPC G06F 7/483; G06F 7/49947; G06T 1/20; G06T 15/80

(57) ABSTRACT

Disclosed is a method of evaluating trigonometric functions in floating point arithmetic. In particular, a range reduction operation is performed to reduce the input argument x into a desired reduced ranges of values within which the trigonometric function is to be evaluated. The range reduction involves a step of computing the product of the input argument x and R, wherein R is an approximation to m/pi (with m=2, for example). The value for R is obtained as a sum of terms R0+R1+ . . . and the value of the first term R0 is configured to ensure that the expression xR0 modulo 4 can be evaluated without floating point rounding error. This can then provide an improved graphics processor operation.

### BACKGROUND

The technology described herein relates to graphics processing and in particular to the operation of a graphics processor (graphics processing unit (GPU)) when evaluating transcendental trigonometric functions in floating point arithmetic.

Many graphics processors now include one or more processing (shader) cores, that execute, inter alia, programmable processing stages, commonly referred to as “shaders”, of a graphics processing pipeline that the graphics processor implements. For example, a graphics processing pipeline may include one or more of, and typically all of: a geometry shader, a vertex shader and a fragment (pixel) shader. These shaders are programmable processing stages that execute shader programs on input data values to generate a desired set of output data, such as appropriately shaded and rendered fragment data in the case of a fragment shader, for processing by the rest of the graphics processing pipeline and/or for output.

It is also known to use graphics processors and graphics processing pipelines, and in particular the shader operation of a graphics processor and graphics processing pipeline, to perform more general computing tasks, e.g. in the case where a similar operation needs to be performed in respect of a large volume of plural different input data values. These operations are commonly referred to as “compute shading” operations and a number of specific compute APIs, such as OpenCL, have been developed for use when it is desired to use a graphics processor and a graphics processing pipeline to perform more general computing operations. Compute shading is used for computing arbitrary information. It can be used to process graphics-related data, if desired, but is generally used for tasks not directly related to performing graphics processing.

A graphics processor shader core is thus a processing unit that performs processing by running (typically small) programs for each “work item” in an output to be generated. In the case of generating a graphics output, such as a render target, such as a frame to be displayed, a “work item” in this regard may be a sampling position, e.g., in the case of a fragment shader, but could also be a vertex, or a ray, for example, depending on the graphics processing (shading) operation in question. In the case of compute shading operations, each “work item” in the output being generated will be, for example, the data instance (item) in the work “space” that the compute shading operation is being performed on.

In graphics processor shader operation, including in compute shading operation, each work “item” will usually be processed by means of an execution thread which will execute the instructions in the shader program in question for the work item in question.

In order to execute shader programs, a graphics processor will include an appropriate execution unit or units (circuit or circuits) for that purpose. The execution unit(s) will include programmable processing circuit(s) for executing shader programs (the “shaders” of graphics processing pipeline).

The actual data processing operations that are performed by the shader execution unit when executing that shader program are usually performed by respective functional units (circuits), such as arithmetic units (circuits), of the execution unit, in response to, and under the control of, the instructions in the (shader) program being executed. Thus, for example, appropriate functional units, such as arithmetic units, will perform data processing operations in response to and as required by instructions in a (shader) program being executed.

The functional units provided in a graphics processor for the purpose of performing operations required by shader programs (and otherwise) may be (and are typically) shared between different shaders (shader stages) of the graphics processing pipeline being executed by the graphics processor. Thus, there will typically be a set of functional units arranged for, and usable for, the execution of shader programs. It would also be possible to provide separate functional units for separate shaders (or for some functional units to be separate and for some to be shared), as desired.

The set of functional units arranged for, and usable for, the execution of shader programs typically include one or more floating point arithmetic units that are operable to, and configured to, perform particular floating point arithmetic operations as required in response to suitable instructions in a (shader) program being executed. For example, modern graphics processors may, and often will, comprise at least a fused multiply-accumulate (FMA) unit that is configured to, and operable, perform fused multiply-accumulate (FMA) operations, and that is accessible by the programmable execution unit such that, in response to suitable instructions in a (shader) program being executed, the fused multiply-accumulate (FMA) unit can be caused to perform a required fused multiply-accumulate (FMA) operation, and return a result of the fused multiply-accumulate (FMA) operation accordingly. Other arithmetic units accessibly by the programmable execution unit may, for example, include a convert (CVT) unit and a special function unit (SFU), that can be similarly caused to perform required arithmetic operations in response to suitable instructions in a (shader) program being executed. By providing such floating point arithmetic units, it is then possible to then perform certain floating point arithmetic operations more efficiently, e.g. using a unit that is dedicated for doing so.

(There may also be various other (non-arithmetic) functional units available to the shader core(s), such as a texturing unit, or a load/store unit, that can be similarly used to perform desired operations in response to suitable instructions in a (shader) program being executed.)

Modern graphics processors are thus typically operable to, and configured to, perform floating point arithmetic, in which data values are encoded in floating point format, wherein a number consists of a signed digit string of specified length in a given base (the ‘mantissa’) that determines the precision to which numbers can be represented and a corresponding signed integer exponent which modifies the magnitude of the number (thus, to derive the value of a floating-point number the mantissa is multiplied by the base raised to the power of the exponent).

Typically there may be many parallel shader cores within a graphics processor such that the graphics processor is capable of performing simultaneous calculations across parallel streams of data, and graphics processors are thus useful accelerators for performing computational work requiring large numbers of calculations to be done. Graphics processors therefore find increasing utility not just for graphics processing work as such, e.g. for rendering a frame (e.g. for display), but also for more general-purpose, e.g. “compute” work, as mentioned above, such as for scientific computing, or for validating transactional blocks within distributed ledger systems, where the computational effort for performing the huge numbers of calculations can usefully be offloaded to a graphics processor.

Thus, as mentioned above, in general, graphics processors may be used either to perform graphics processing work as such, e.g. to render a frame, or to perform more general-purpose, e.g. “compute”, work. In both cases, the relevant API requirements specify that the graphics processor should be able to handle certain types of functions, including transcendental functions, such as trigonometric (sine and cosine) functions.

The API will typically also specify a required precision to which the graphics processor should be able to evaluate such functions. For example, for graphics processing work, the required precision is typically relatively lower, as the rendered image quality may be relatively tolerant to imprecision. Therefore, graphics APIs, such as Vulkan, DirectX 12 and OpenGL ES, often have relatively relaxed (lower) precision requirements. However, when performing more general computing tasks, the actual results of the calculations may be more important as such, and so specific “compute” APIs, such as OpenCL, typically mandate higher precision requirements. For example, OpenCL specifies a precision of less than 4 units in the last place (<4 ULP) for sine and cosine functions in single-precision (i.e. FP32) floating point format.

Various approaches have therefore been developed in order to evaluate such transcendental functions to the required degree of precision. For instance, in some arrangements, a predominately fixed-function hardware approach may be used. However, this is associated with relatively higher area cost. Thus, in some modern graphics processor arrangements, such functions are instead evaluated predominately in shader code by the programmable execution unit of the graphics processor executing a suitable sequence of instructions, and performing, using the set of functional units accessible by the programmable execution unit as appropriate, a corresponding set of processing operations for evaluating the trigonometric function.

The present Applicants however believe that there remains scope for improved (e.g. faster) evaluation of floating point trigonometric functions in shader code, and hence improved graphics processor operation.

### BRIEF DESCRIPTION OF THE DRAWINGS

The present technology will be described, by way of example only, with reference to embodiments thereof as illustrated in the accompanying drawings, in which:

FIG. 1 shows schematically a graphics processing system within which the technology described herein can be performed;

FIG. 2 shows schematically a graphics processing pipeline that may be implemented within a graphics processor;

FIG. 3 shows schematically the relevant functional units of a graphics processor shader core that may be used according to an embodiment;

FIG. 4 shows schematically further details of a graphics processor shader core that may be relevant according to embodiments of the technology described herein;

FIG. 5 shows the operation of a processing element of the graphics processor shader core; and

FIG. 6 is a flow chart illustrating the selection of an appropriate processing pathway for performing a range reduction operation for evaluating a transcendental trigonometric function according to an embodiment;

FIG. 7 is a flow chart illustrating a range reduction operation for evaluating a transcendental trigonometric function according to an embodiment; and

FIG. 8 schematically shows a table look up according to an embodiment.

Like reference numerals are used for like components where appropriate in the drawings.

### DETAILED DESCRIPTION

A first embodiment of the technology described herein comprises a method of operating a graphics processor comprising a programmable execution unit that is operable to execute programs to perform data processing, the programmable execution unit having access to a set of one or more floating point arithmetic units configured to perform floating point arithmetic operations, wherein the programmable execution unit when executing a program to perform data processing is operable in response to instructions in the program to cause the floating point arithmetic units to perform respective floating point arithmetic operations, the method comprising:
when executing a program to perform data processing that requires a sinusoidal or cosinusoidal trigonometric function to be evaluated to a first precision for a particular input argument x, wherein the input argument x is defined in a first floating point format having an exponent E and a p-bit mantissa:
the programmable execution unit executing a certain sequence of instructions for performing a corresponding sequence of processing operations for evaluating the trigonometric function to the first precision, the sequence of processing operations including one or more sequences of arithmetic operations to be performed using the set of floating point arithmetic units accessible by the programmable execution unit, the sequence of processing operations evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the product of the input argument x and R,
where R is an approximation to m/pi, with m being a rational number, and wherein the value for R is obtained as a sum of terms, R0+R1+ . . . , each term in the sum of terms being smaller compared to the previous term, such that the product of the input argument x and R can be determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the expression x.R0−z can be evaluated by a sequence of one or more arithmetic operations performed using the set of floating point arithmetic units accessible by the programmable execution unit without any floating point rounding error.

A second embodiment of the technology described herein comprises a graphics processor comprising:
a programmable execution unit that is operable to execute programs to perform data processing;
the programmable execution unit having access to a set of one or more floating point arithmetic units configured to perform floating point arithmetic operations, wherein the programmable execution unit when executing a program to perform data processing is operable in response to instructions in the program to cause the floating point arithmetic units to perform respective floating point arithmetic operations,
the graphics processor configured to:
when executing a program to perform data processing that requires a sinusoidal or cosinusoidal trigonometric function to be evaluated to a first precision for a particular input argument x, wherein the input argument x is defined in a first floating point format having an exponent E and a p-bit mantissa:
in response to the programmable execution unit executing a certain sequence of instructions for performing a corresponding sequence of processing operations, the sequence of processing operations including one or more sequences of arithmetic operations to be performed using the set of floating point arithmetic units accessible by the programmable execution unit, for evaluating the trigonometric function to the first precision:
perform a range reduction operation to reduce the value of the input argument x into a reduced range of values within which the trigonometric function is to be evaluated; and
evaluate the trigonometric function for the reduced input argument;
wherein reducing the value of the input argument x into the desired range of values for evaluating the trigonometric function involves a step of computing a value for the product of the input argument x and R,
where R is an approximation to m/pi, with m being a rational number, and wherein the value for R is obtained as a sum of terms, R0+R1+ . . . , each term in the sum of terms being smaller compared to the previous term, such that the product of the input argument x and R can be determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the expression x.R0−z can be evaluated by a sequence of one or more arithmetic operations performed using the set of floating point arithmetic units accessible by the programmable execution unit without any floating point rounding error.

The technology described herein relates generally to graphics processors (graphics processing units (GPUs)) that comprise a programmable execution unit and a set of one or more functional units accessible by the programmable execution unit including at least one floating point arithmetic unit that is configured to, and operable to, perform floating point arithmetic operations (e.g. a fused multiply-accumulate (FMA) unit configured to perform fused multiply-accumulate (FMA) operations) in response to instructions within a program to perform data processing being executed by the programmable execution unit. In particular, the technology described herein relates to the operation of such a graphics processor when executing a program to perform data processing operations that require the evaluation of a sinusoidal or cosinusoidal trigonometric function in floating point arithmetic.

According to the above embodiments of the technology described herein the evaluation of the sinusoidal or cosinusoidal trigonometric function is done, at least for larger input arguments (e.g. input arguments that are above a certain, e.g. predefined threshold value, as will be explained further below), by first performing a so-called “range reduction” operation to reduce the value of the input argument into a reduced range of values within which the trigonometric function is to be evaluated (which may, e.g., be, and in an embodiment is, a reduced range of values within which the trigonometric function can be more easily (and accurately) evaluated, e.g. using a suitably defined polynomial function that approximates the trigonometric function within the reduced range of values).

For instance, for a given input argument, “x” (in radians), the input argument x can always be reduced into the interval [−pi, pi], where the reduced argument u is equal to x−2k.pi where k is the nearest integer to x/(2pi). In fact, due to the known symmetry and transformations between the sine and cosine functions, the input argument x can be further reduced using the expression x−k.pi/2 into the interval [−pi/4, pi/4], with k now being the nearest integer to 2x/pi, and with the sign then being corrected as needed, depending on the function that is being evaluated (i.e. sine or cosine). In some embodiments, therefore, the input argument may be, and is, reduced to a value within the interval [−pi/4, pi/4]. In that case, the range reduction may thus involve computing a value for the product of the input argument x and R, where R is an approximation to 2/pi.

Thus, for ease of explanation, various examples and embodiments will be described below for the situation where R=2/pi.

However, the skilled person will understand that various arrangements would be possible in this respect and the reduced range may in general be any suitable and desired reduced range of values, with the value of R being determined accordingly. For instance, the general additive range reduction is x−k.C which for suitable k being the nearest integer to x/C reduces the input argument x to the range [−C/2, C/2], where C can be any suitable (irrational) number defining an appropriate range for the function that is being evaluated.

Once the range reduction has been performed, and the original input argument x reduced to a suitable reduced input argument within the desired (reduced) range of values, the trigonometric function can then be (and is) evaluated for the reduced input argument. For example, and in an embodiment, the evaluation of the trigonometric function for the reduced input argument is done using a suitable polynomic function that approximates the trigonometric function within the reduced range of values.

According to the technology described herein, therefore, in order to evaluate a trigonometric function for a particular input argument x (e.g., and in particular, for relatively larger input arguments, e.g. above a certain, e.g. desired, threshold value, as will be explained further below), this is done in essentially two steps: firstly, by performing a range reduction to reduce the input argument x into a desired (reduced) range of values within which the trigonometric function is to be evaluated; and then evaluating the trigonometric function for the reduced input argument accordingly.

A result of the evaluation of the trigonometric function for the reduced input argument can then be (and in an embodiment is) provided, e.g. for further processing, depending on the processing work that the graphics processor is being used to perform. For example, when the graphics processor is being used for compute work, e.g. for scientific computing, the result of the evaluation of the trigonometric function may itself be provided for output, if that is the calculation that is being offloaded to the graphics processor. However, it is also the case, and often will be the case, that the evaluation of the trigonometric function is merely one step of a larger processing task (e.g. a larger calculation) that is being performed by the graphics processor. In that case, the result of the evaluation of the trigonometric function may be used as input to a further part of the program to perform data processing. Various arrangements would be possible in this regard.

Accordingly, the method may comprise performing further processing based on the result of evaluating the trigonometric function. Thus, in embodiments, a result of the evaluation of the trigonometric function is then provided for further processing, and the graphics processor is then caused (e.g. by executing suitable further instructions) to use the result of the evaluation of the trigonometric function for further processing, e.g., and in an embodiment, to generate a final result, e.g. for output.

The technology described herein relates particularly to the “range reduction” operation. In this respect, it will be appreciated that although the range reduction operation is conceptually simple, it can be challenging to implement range reduction in floating point arithmetic with desired precision, especially for larger input arguments.

According to the technology described herein, as will be explained further below, the range reduction operation generally involves a step of computing a value for the product of the input argument x and R, where R is an approximation to m/pi, with m being a rational number.

For example, in embodiments, the range reduction operation involves computing a value for the fractional part of the input argument x and R, where R is an approximation to m/pi, with m being a rational number. To do this, in embodiments, a value for the product of the input argument x and R is first computed, and this result is then evaluated modulo 1 in order to give the fractional part. As will be explained further below, computing the fractional part of the input argument x and R effectively reduces the input argument x into the desired reduced range of values (in particular, into the range of values [−C/2,C/2], where C=1/R). For example, in embodiments, R is an approximation to 2/pi.

However, because pi is a transcendental number, the product of the input argument x and R can then be arbitrarily close to an integer. This then means that computing the fractional part of the product of the input argument x and R with the desired precision may require storing enough digits of R to ensure there is enough precision after the binary point to guarantee that the fractional part can be calculated with the full desired precision (i.e. a full 24 bits for single-precision floating-point (FP32) format values). Existing range reduction algorithms may therefore either suffer from a lack of accuracy, or may be relatively inefficient to implement on a graphics processor, requiring many processing cycles, and thus reducing performance.

The technology described herein therefore provides a novel range reduction operation that can be used for higher precision (e.g. compute) applications (and in particular for relatively larger input arguments x, e.g. that are above a certain, e.g. predefined threshold) and that can be implemented on a graphics processor using relatively fewer (program) instructions (and hence fewer processing cycles). In other words, the technology described herein provides a novel range reduction operation that, as will be explained further below, can be (and is) better optimised for execution in shader code on a graphics processor, in particular to make better, more efficient use of the existing graphics processor shader core hardware circuitry (in particular the floating point arithmetic units), in order to therefore provide an improved overall graphics processor operation, e.g., and in an embodiment, without requiring significant additional area (e.g. compared to providing a dedicated range reduction (hardware) circuit).

The technology described herein may therefore provide various benefits compared to other possible approaches.

As mentioned above, the range reduction operation according to the technology described herein involves computing a value of the product of the input argument x and R, where R is an approximation to m/pi, with m being a rational number, with the value of m being selected appropriately depending on the desired reduced range of values within which the trigonometric function is to be evaluated (e.g., and in embodiments, m=2 such that R is an approximation to the value of 2/pi). In this respect, the range reduction operation in the technology described herein is in an embodiment, and generally, performed following the principles set out in M. H. Payne and R. N. Hanek, “Radian reduction for trigonometric functions”, j-SIGNUM, vol. 18, pp 19-24, January 1983 (the “Payne-Hanek” approach).

In particular, the range reduction operation according to the technology described herein in an embodiment (effectively) involves computing a value of the fractional part of the product of the input argument x and R. Thus, in an embodiment, the range reduction operation effectively comprises computing the function u=C.frac(xR), where u is the reduced input argument, C=1/R, x is the input argument, and frac( ) is the fractional part of the product of the input argument x and R. The evaluation of the fractional part of the product of the input argument x and R may, e.g., be, and in an embodiment is, done by performing a modulo 1 operation on the product of the input argument x and R as determined herein. That is, in embodiments, after computing a value for the product of the input argument x and R (which is in an embodiment done as described herein), the result of that computation is then computed modulo 1 give the fractional part.

In order to be able to compute the product of the input argument x and R, the range reduction operation thus requires a suitable value for R to be obtained. Further, the value for R must be computed to sufficient precision to allow (the fractional part of) the product of the input argument x and R to be computed to the desired (first) precision.

According to the technology described herein, therefore, the value for R is obtained as a sum of terms, R=R0+R1+ . . . , . . . where each term in the sum of terms is smaller than the previous term. So, the first term R0 is generally selected to be relatively closer to R, with the remaining terms R1, etc., providing refinements to get closer to the desired precision. In general, the number of terms in the sum may therefore depend on the desired precision. For example, for single-precision (e.g. FP32) floating point format, a sum of four terms may be, and in an embodiment is, used. However, for reduced-precision (e.g. FP16) floating point format, a sum of two terms may provide sufficient precision. Various arrangements would be possible in this regard.

The sum of terms, R=R0+R1+ . . . , may be used to approximate the (full) value of m/pi (e.g. 2/pi) itself. However, following the approach set out in K. C. Ng, “Argument reduction for huge arguments: Good to the last bit”, tech. rep., 1992, section 2.5, the sum of terms, R=R0+R1+ . . . , may instead to be used to approximate only a significant part of the value of m/pi (e.g. a subset of the bits of m/pi). Various arrangements would be possible in this regard. In particular, for larger input argument exponents, it is shown in K. C. Ng, “Argument reduction for huge arguments: Good to the last bit”, tech. rep., 1992, that the higher order bits of the R expansion do not influence the final result, and thus these bits do not need to be used (or therefore stored). Thus, depending on the size of the input argument exponent, different sets of R0, R1, . . . , values may be (and according to the technology described herein in an embodiment are) used as appropriate, with the different sets approximating (only) the significant part of R, and with increasing numbers of higher order bits being discarded for increasing input argument exponents.

Computing the value of the (fractional part of the) product of the input argument x and R thus generally involves steps of computing the product of the input argument x with each of the respective terms, R0, R1, . . . , in the sum of terms that is used to approximate the value for R, which respective products are then added together (such that the product of the input argument x and R is effectively approximated as a sum of the respective products of the input argument x with each of the terms R0, R1, . . . that are used to approximate the value for R, i.e. such that the product of the input argument x and R is evaluated by computing in floating point the sum x·R0+x·R1 . . . ). In general, each step of multiplication and/or addition in floating point may introduce a respective floating point rounding error. Thus, in order to achieve the desired overall precision, a compensation term, “t”, is in an embodiment also calculated that accounts for and tracks the floating point rounding errors associated with each of the steps of multiplication and/or addition used for the computation of the value of the (fractional part of the) product of the input argument x and R.

Thus, in embodiments, the method further comprises (the programmable execution unit executing instructions for) computing a compensation term t that accounts for the rounding errors in evaluating the product of the input argument x and R. This then allows the range reduction to be performed at the desired (first) precision (e.g. the precision mandated by the relevant API). It will be appreciated that computing the compensation term, t, can generally be quite intensive, requiring many additional operations (and hence processing cycles), in order to track the floating point rounding errors for each of the respective terms used during the calculation.

According to the technology described herein, therefore, the value of the first term in the sum of terms that is used to approximate the value for R, i.e. the value of “R0”, is configured to ensure that the product of the input argument x and the first term R0 modulo 4 can be fitted exactly into a single floating point value of a desired format (e.g. a single single-precision (FP32) floating point value), e.g. a format that the floating point arithmetic unit (and the graphics processor generally) is configured to handle (i.e. the same (first) floating point format that the input argument x is provided in).

For example, for an input argument x comprising a p-bit floating point number, the present Applicants have recognised that a suitable selection of the first term, R0, is oₚ₋₂(R), i.e. 2/pi rounded to p−2 bits (e.g. 22 bits of precision for single single-precision (FP32) floating point where there are 24 mantissa bits).

(More generally, the first term R0 could be selected as o_{p-q}(R), where q≥2. However, in embodiments, as described above, q=2 as dropping further bits does not then provide any benefit (but may increasingly lose precision).)

The Applicants have found that with this rounding, the result of the expression x.R0−z, where “z” is selected to implement a modulo-by-4 operation (such that the product of the input argument x and the first term, R0, in the sum of terms that is used to approximate R is evaluated within the range [0, 4]), can then be evaluated using relatively fewer instructions, e.g., and in an embodiment, by a single fused multiply-accumulate (FMA) operation, e.g., and in an embodiment, in a single processing cycle.

For example, as mentioned above, the set of floating point arithmetic units accessible by the programmable execution unit in an embodiment includes at least one fused multiply-accumulate (FMA) unit that is operable to, and configured to, perform fused multiply-accumulate (FMA) operation in response to suitable instructions in the shader program. Thus, in embodiments, the expression x.R0−z (i.e. the product of the input argument x and the first term R0 modulo 4) is evaluated by including a suitable instruction to cause the at least one fused multiply-accumulate (FMA) unit to perform a corresponding one fused multiply-accumulate (FMA) operation for evaluating such expression. An appropriate value of “z” may also be suitably evaluated using an appropriate set of floating point arithmetic operations.

Thus, in embodiments, the sequence of instructions for evaluating the trigonometric function includes a sub-sequence of instructions that perform the sequence of arithmetic operations for evaluating the expression x.R0−z, wherein the sub-sequence of instructions for evaluating the expression x.R0−z includes a set of instructions for determining the value of z, and a further instruction to cause the fused multiply-accumulate unit to perform a respective fused multiply-accumulate operation that evaluates the expression x.R0−z using the determined value of z.

In this respect, the technology described herein in an embodiment takes advantage of the internally wider precision of the fused-multiple-accumulate (FMA) operation to represent the intermediate product x.R0 (which intermediate product itself may generally not fit into a single floating point value of the desired format), but with suitable selection of z to ensure that the final result of evaluating the expression x.R0−z (i.e. the product x.R0 modulo 4) does fit exactly into a single floating point value of the desired format.

The modulo-by-4 operation (and hence the selection of a suitable value for “z”) is therefore beneficial in ensuring that the result of the expression x.R0−z (the product of the input argument x and the first term R0 modulo 4) fits exactly into a single floating point value of the desired format.

By configuring the value of the first term, R0, such that the result of the expression x.R0−z (the product of the input argument x and the first term R0 modulo 4) fits exactly into a single floating point value of the desired format, this further means that the value for the product of the input argument x and the first term R0 can be evaluated using the floating point arithmetic units that are accessible by the programmable execution unit without any associated floating point rounding error. Accordingly, there is then no need to track any floating point rounding error associated with the product of the input argument x and the first term R0, which can therefore (and does) significantly simplify the computation of the compensation term t. This again therefore reduces the number of instructions (and hence processing cycles) needed to perform the range reduction operation, and hence allows for a more efficient overall graphics processor operation when evaluating such transcendental trigonometric functions.

That is, the technology described herein intentionally configures the first term R0 to ensure that the result of evaluating the expression x.R0−z (i.e. the product of the input argument x and the first term R0 modulo 4) can be fitted exactly into a single floating point value of a desired format, even if this requires a suboptimal selection of the first term R0 (i.e. even if a more precise approximation of R could in principle be achieved using a different first term R0, e.g., and in particular, by rounding R to the full p bits of available mantissa), and in doing this simplifies both the determination of the product of the input argument x and the first term R0 itself (i.e. the evaluation of the expression x.R0−z, as described above), and also the subsequent computation of the required compensation term since there is then no rounding error associated with that product that needs to be tracked. That is, the first term R0 is configured and selected to better optimise these steps of the range reduction operation for execution by the graphics processor's programmable execution unit (i.e. in shader code), in particular such that the range reduction operation can be performed using fewer (program) instructions (and hence fewer processing cycles).

The actual values of R0, R1, . . . , can be, and in an embodiment are, selected from a suitable table, e.g. a look-up table, that is provided for this purpose. This table can generally be configured in advance for storing suitable (sets of) values such that the values can then be selected and obtained (i.e. read in) as necessary during shader program execution, e.g. in response to the programmable execution unit executing an appropriate sequence of instructions included within the shader program being executed to load into the graphics processor a suitable set of R0, R1, . . . values for approximating the value of R. The selection of the first term R0 (and the other terms) thus in an embodiment comprises performing an appropriate lookup to such table in which the values are stored. This lookup may be performed in any suitable and desired manner. For instance, in an embodiment, the set of R0, R1, . . . , values are read in via the graphics processor load/store cache. The set of R0, R1, . . . , values can then be suitably stored, e.g. in appropriate registers accessible by the programmable execution unit, for use during the range reduction operation.

In the technology described herein, as described above, for a particular set of R0, R1, . . . , values that can be used to approximate a value for R, the value of the first term, R0, is configured such that the product of the input argument x and the first term R0 modulo 4 can be fitted exactly into a single floating point value of the first floating point format. The expression x.R0−z (the product of the input argument x and the first term R0 modulo 4) can then be evaluated without any floating point rounding error by performing a suitable sequence of one or more arithmetic operations (e.g. a fused multiply-accumulate operation) that can be (and are) performed using the set of floating point arithmetic units accessible by the programmable execution unit. Thus, the technology described herein provides in embodiments a novel table configuration in which the sets of R0, R1, . . . , values that are used for approximating the value of R are configured in this particular way to facilitate an improved graphics processor operation.

The effect and benefit of this is then that the range reduction operation can be implemented using relatively fewer instructions (and hence fewer processing cycles).

This then provides an overall more efficient graphics processor operation. For example, although described above in relation to a single instance of evaluating a trigonometric function, it will be appreciated that a typical data processing program may include many instances where evaluation of trigonometric functions is required, such that the technology described herein can significantly improve the overall graphics processor operation.

The sets of R0, R1, . . . values (and the table that stores them) may otherwise be configured in any suitable manner and the selection (lookup) of the appropriate R0, R1, . . . , values performed accordingly using any other suitable and desired information.

For example, and in embodiments, there are plural different sets of R values (i.e. a plurality of different available R0 values) that can be (and are) selected based on the input argument x.

In this respect, the present Applicants further recognise that the number of bits required in the approximation of m/pi to achieve the desired precision depends also on the size, e.g. value, of the input argument x. In particular, the present Applicants have recognised that for an input argument x having exponent E and a p-bit mantissa, at least for exponents E that are larger than the number of bits p in the mantissa, the top significant bits (i.e. the top (E-p) bits) can be dropped without loss of precision as they do not contribute to the fractional part of the product of the input argument x and R. This then means that significantly fewer bits need to be kept in the computation, and hence these bits do not need to be stored (and in an embodiment therefore are not stored in the table that stores the sets of R0, R1, . . . values). However, the number of bits that can be dropped depends on the size of the input argument exponent.

That is, the table that stores the R0 values may, e.g., be, and in an embodiment is, configured to store a plurality of different respective sets of values for R0, R1, . . . , that are suitably configured to be used for different sized input arguments x, and the selection (lookup) of the first term R0 (i.e. the selection of the set of terms R0, R1, . . . , that is used for approximating the value of R) is therefore additionally done based on the input argument exponent E.

Thus, in embodiments, the (value of the) first term, R0, in the sum of terms that is used to approximate the value for R is selected from a plurality of available values for the first term, R0, based on the input argument exponent E.

For instance, in embodiments, as will be described further below, the range reduction operation of the first and second embodiments of the technology described herein is in an embodiment, and in particular, used for input arguments x for which the exponent E is larger than the number of available mantissa bits p. Thus, for an input argument x having exponent E and a p-bit mantissa, the range reduction operation of the first and second embodiments of the technology described herein is in an embodiment used, and in an embodiment only used, for input arguments where the exponent E is greater than or equal to the number of available mantissa bits p, with the lookup then being performed accordingly based on the (e.g. size, e.g. value, of) the input argument x, e.g. in the manner described above.

Various other arrangements would be possible in this respect. For example, in embodiments, the table may be configured to only store R0, R1, . . . , values for one particular floating point format (e.g. a floating point format that the graphics processor is configured to handle), in which case all of the entries (e.g. the R0 values) in the table may be configured for use with that floating point format, e.g. to ensure that the respective expressions x.R0−z (the respective products x.R0 modulo 4) can be fitted exactly into a single floating point value of that same format, as described above. So, for instance, if the graphics processor is configured to handle single-precision (i.e. FP32) floating point format numbers, the table may be designed and configured to store suitable sets of R0, R1, . . . , values for that format, e.g. with the values of R0 being configured based on a rounding of m/pi to p-2 bits where p=24 (i.e. the number of available mantissa bits).

It would however also be possible for the table to be configured to store suitable sets of R0, R1, . . . , values for a plurality of a different floating point formats, with different sets of entries being stored for different floating point formats (e.g. FP16, FP32, FP64), and this may be done in some other embodiments. In that case, the selection (lookup) of the appropriate R0 value may therefore be additionally based on the floating point format that is being used. Various arrangements would be possible in this regard.

Subject to the particular requirements of the technology described herein, the evaluation of the trigonometric function can otherwise be performed in any suitable and desired manner.

For example, as mentioned above, the range reduction may be, and in some embodiments is, performed to reduce the input argument into the range of values [−pi, pi]. However other arrangements would be possible. For instance, the range reduction may be, and in some embodiments is, performed to reduce the input argument into the range of values [−pi/4, pi/4] or [0, pi/4], noting that there are well-defined relationships/transformations between sine and cosine within such intervals. That is, in the case where the range reduction operation is performed to reduce the input argument into the range of values [−pi/4, pi/4] or [0, pi/4], an additional sign correction may be required depending on the trigonometric function (i.e. sine or cosine) that is being evaluated. In this respect, it will be appreciated that there is a further benefit in evaluating the product of the input argument x and the first term, R0, in the sum of terms that is used to approximate the value of R modulo 4 since the result of the modulo-by-4 operation can then be (and in an embodiment is) used to select the correct quadrant for performing the desired sign correction. This can therefore further simplify the program and hence improve the overall graphics processor operation.

Once the input argument has been suitably reduced into the desired (reduced) range of values, the trigonometric function can then be, and is, evaluated accordingly using the reduced input argument. This can generally be done in any suitable and desired manner, e.g. in the normal manner for such techniques. For example, and in an embodiment, this is done using a polynomial function that approximates the trigonometric function within the desired (reduced) range of values. This can be implemented in any suitable and desired manner. For instance, in some embodiments, this is done using a dedicated instruction (e.g. a single ‘FSIN’, ‘FCOS’ or ‘FSINCOS’ instruction) that is configured to, and operable to, evaluate the trigonometric function within the desired (reduced) range of values, e.g. using an appropriate special function arithmetic unit. However, it would also be possible to perform the evaluation using a suitable shader program subroutine that evaluates the polynomial function, for example. Various arrangements would be possible in this regard.

It will be appreciated that whilst described above in relation to evaluating sinusoidal and/or cosinusoidal trigonometric functions, the technology described herein may also be, and in an embodiment is, used for evaluating the tangent function (i.e. the ratio of sine/cosine). In that case, the range reduction operation can be, and in an embodiment is, performed in common for evaluating both the sine and cosine functions, and the ratio is then evaluated accordingly (e.g. by evaluating both the sine and cosine functions (e.g. using an ‘FSINCOS’ instruction), determining a reciprocal of the cosine function and then multiplying by sine). Similarly, the range reduction operation according to the technology described herein may also be used when evaluating any other suitable combinations of trigonometric functions.

As mentioned above, in the technology described herein, the values R0, R1, . . . , are in an embodiment selected from a suitable table that stores the different possible sets of R0, R1, . . . values. In order to avoid possible underflow for very large input arguments (since the fractional part of the product of the input argument x and R may be a very small number if the product of the input argument x and R is very close to an integer), the values R0, R1, . . . , that are stored in the table are in an embodiment scaled by a suitable factor (e.g. 2²⁸). Thus, the method may further comprise scaling/re-scaling the values as appropriate as they are looked up from the table. Various arrangements would be possible in this regard.

As described above, the range reduction operation is in an embodiment executed in shader code, such that the operation of the graphics processor in this way is in an embodiment controlled by the graphics processor's programmable execution unit executing instructions included into an appropriate shader program (or shader programs) to perform the operations described above.

The shader program(s) that are executed by the programmable execution unit can be prepared and generated in any suitable and desired manner.

In an embodiment, it or they is generated by a compiler (the shader compiler) for the graphics processor of the graphics processing system in question (and thus the processing circuit that generates the shading program in an embodiment comprises an appropriate compiler circuit). The compiler is in an embodiment executed on an appropriate programmable processing circuit of the graphics processing system.

In a graphics processing system that is operable in the manner of the technology described herein, in embodiments of the technology described herein at least, a compiler, e.g. executing on a host processor, will generate and issue to the graphics processor one or more shader programs that when executed will perform the required operations for evaluating the transcendental trigonometric function in accordance with the technology described herein, with the graphics processor (the programmable execution unit of the graphics processor) then executing the programs to perform the required operations.

The operation of the technology described herein can thus be (and is) implemented and triggered by including appropriate instructions in the shader program to be executed by the programmable execution unit that will trigger the desired operations to be performed for evaluating the transcendental trigonometric functions (with the execution unit then performing the desired operations including the sequence of operations using the floating point arithmetic units for performing the range reduction operations as described above when it reaches (executes) the relevant instruction in the shader program).

Such instructions can be included in a shader program to be executed by the programmable execution unit in any suitable and desired manner and by any suitable and desired element of the overall data (graphics) processing system.

For instance, in an embodiment, the instructions are included in the shader program by the compiler (the shader compiler) for the graphics processor. Thus the compiler in an embodiment inserts a suitable set of instructions at the appropriate point in the shader program at which the transcendental trigonometric function is required to be evaluated.

In an embodiment, a suitable set of instructions is included in the shader program that is to be executed by the graphics processor by the compiler in response to an appropriate indication (e.g. a “sino” or “coso” call), included in the (high level) shader program that is provided by the application that requires the graphics processing. Thus, e.g., and in an embodiment, an application program will be able to include an explicit indication of a need for a transcendental trigonometric function evaluation, with the compiler then, in the technology described herein, including an appropriate set of instructions in the compiled shader program in response to that. It may also be possible for the compiler to include suitable instructions of its own accord, e.g. in the case where the compiler is able to assess the shader program being compiled to identify when and where to include such instructions, even in the absence of an explicit indication of that.

In an embodiment, the compiler analyses the shader program code that is provided, e.g. by the application on the host processor that requires the graphics processing, and includes suitable sets of instructions at the appropriate point(s) in the shader program (e.g. by inserting the instruction(s) in the (compiled) shader program).

The technology described herein also extends to and includes such operation of a compiler.

Thus, a further embodiment of the technology described herein comprises a method of compiling a shader program to be executed by a programmable execution unit of a graphics processor that is operable to execute graphics processing programs to perform graphics processing operations;
the method comprising:
for a shader program to be executed by a programmable execution unit of a graphics processor, the programmable execution unit having access to a set of one or more floating point arithmetic units configured to perform floating point arithmetic operations, wherein the programmable execution unit when executing a program to perform data processing is operable in response to instructions in the program to cause the floating point arithmetic units to perform respective floating point arithmetic operations
including in the program a set of instructions to:
when the program to perform data processing that requires a sinusoidal or cosinusoidal trigonometric function to be evaluated to a first precision for a particular input argument x, wherein the input argument x is defined in a first floating point format having an exponent E and a p-bit mantissa:
cause the programmable execution unit to perform a corresponding sequence of processing operations for evaluating the trigonometric function to the first precision, the sequence of processing operations including one or more sequences of arithmetic operations to be performed using the set of floating point arithmetic units accessible by the programmable execution unit, the sequence of processing operations evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the product of the input argument x and R,
wherein R is an approximation to m/pi, with m being a rational number, and wherein the value for R is obtained as a sum of terms, R0+R1+ . . . , each term in the sum of terms being smaller compared to the previous term, such that the product of the input argument x and R can be determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the expression x.R0−z can be evaluated by a sequence of one or more arithmetic operations performed using the set of floating point arithmetic units accessible by the programmable execution unit without any floating point rounding error.

As will be appreciated by those skilled in the art, the methods according to this additional embodiment of the technology described herein relating to the compiler operation can, and in embodiments do, include any one or more or all of the features of the technology described herein relating to the operation of the graphics processor described herein according to the first and second embodiments presented above, as appropriate.

The compiler (the compiler processing circuit) is in an embodiment part of, and in an embodiment executes on, a central processing unit (CPU), such as a host processor, of the graphics processing system, and is in an embodiment part of a driver for the graphics processor that is executing on the CPU (e.g. host processor).

In this case, the compiler and compiled code will run on separate processors within the overall graphics processing system. However, other arrangements would be possible, such as the compiler running on the same processor as the compiled code, if desired.

The compilation process (the compiler) can generate the shader program in any suitable and desired manner, e.g., and in an embodiment, using any suitable and desired compiler techniques for that purpose.

Thus, in an embodiment, the shader program is generated by the compiler, and the compiler is arranged to include within the shader program the instructions that are used in the technology described herein. Other arrangements would, of course, be possible.

The generated shader program can then be issued to the programmable execution unit of the graphics processor for execution thereby, e.g. in order to control the operation of the graphics processor in the manner described above.

Thus, as described above, the graphics processor when executing the compiled shader program is configured to execute the instructions in the shader program and perform the required processing operations accordingly in response to such instructions.

For instance, the compiler is in an embodiment configured to include into the shader program a first sequence of instructions that when executed by the graphics processor programmable execution unit cause the graphics processor to obtain a suitable set of R0, R1, . . . , values for approximating the value for R. For example, this may include a sequence of instructions for setting up the relevant registers and then loading in the desired set of R0, R1, . . . , values accordingly.

This first sequence of instructions may thus then be followed in the shader program by a second sequence of instructions that when executed by the graphics processor programmable execution unit cause the graphics processor to evaluate the product of the input argument x and the first term, R0, in the sum of terms that is used for approximating the value for R. For instance, the second sequence of instructions may, and in an embodiment does, include a sequence of instructions including at least one fused multiply-accumulate (FMA) instruction that explicitly evaluates the product of the input argument x and the first term R0 modulo 4, as mentioned above, and this sequence of instructions can be (and is) accordingly executed without introducing any associated floating point rounding error.

The second sequence of instructions may accordingly then be followed by third or further sequences of instructions that when executed by the graphics processor programmable execution unit cause the graphics processor cause the graphics processor to compute the products of the input argument with remaining terms in the sum of terms that is used for approximating the value for R, and in an embodiment also to compute the compensation term t, etc., as described above.

Once the sequence of instructions to perform the range reduction operation is completed, the shader program may then include a further sequence of instructions that when executed by the graphics processor programmable execution unit cause the graphics processor to evaluate the trigonometric function within the reduced range.

Thus, at execution time, when the shader program is executed, the programmable execution unit is accordingly configured to execute such instructions that have been included into the shader program and perform the required processing operations accordingly in response to such (sequences of) instructions.

The shader program(s) may of course, and typically will, include various other instructions to perform other processing operations as part of a wider processing task that is being performed and that requires as part of the wider processing task the evaluation of a transcendental trigonometric function.

In embodiments the graphics processor is selectively operable in the manner described above, e.g., and in an embodiment, in dependence on the level of precision with which the trigonometric function is desired to be evaluated (e.g. based on the application requirements) and/or the size of the input argument. Thus, in embodiments, the graphics processor may be operable to, and configured to, implement two or more, and in an embodiment at least three, different processing paths for evaluating trigonometric functions, with each processing path implementing its own respective range reduction operation, and with the graphics processor then being operable to, and configured to, select a suitable processing path as desired. In this respect, it will be appreciated that, as mentioned above, graphics processing work typically has lower precision requirements than more general, purpose, “compute”, processing work.

As alluded above, the novel range reduction operation described above is particularly suited for higher precision (e.g. compute) applications.

Thus, in embodiments, the graphics processor is operable to perform different range reduction operations depending on the desired precision. In that case, an initial step of determining that the program to perform data processing that requires a sinusoidal or cosinusoidal trigonometric function to be evaluated to a first, higher precision may be performed.

Thus, when it is determined or mandated that the program to perform data processing that requires a sinusoidal or cosinusoidal trigonometric function to be evaluated to the first, higher precision, a suitable processing pathway can then be selected that is operable to implement the novel range reduction operation according to the technology described herein. On the other hand, if it is determined that the function does not need to be evaluated to the first, higher precision (i.e. a lower precision is acceptable), the range reduction operation may be performed in a different manner.

The novel range reduction operation according to the technology described herein could then be used for all applications where it is determined that the first, higher precision is required. However, the present Applicants also recognise that this may not be necessary, and that the novel range reduction operation according to the technology described herein is in particular suitable for relatively larger input arguments, e.g. input arguments that are above a certain, e.g. predefined, threshold value. This certain, e.g. predefined, threshold value may, for example, be determined based on the floating point format. For instance, for single-precision (i.e. FP32) floating point format, a suitable threshold for using the novel range reduction operation according to the technology described herein may be for input arguments |x|≥2²². Various other arrangements would of course be possible.

Thus, in embodiments, the graphics processor when evaluating trigonometric functions to the first precision is operable to perform different range reduction operations depending on the size of the input argument, and the method may thus comprise determining that the input argument x is above a certain threshold value. On the other hand, for input arguments below the certain threshold size, the range reduction operation may be performed in a different manner. For very small input arguments, no range reduction may be required.

The selection of the processing path (and hence range reduction operation) to use may be performed by the graphics processor itself during shader program execution. For instance, the shader program may include one or more conditional instructions to allow the program to branch depending on the desired level of precision and/or the size of the input exponent.

It would however also be possible for the driver for the graphics processor (or the compiler when compiling the shader program) to at least make an initial determination based on the desired level of precision since that will generally be known to the application programmer. The compiler may then include an appropriate set of instructions for implementing a higher or lower precision pathway accordingly based on the desired level of precision. On the other hand, even if the driver has determined that the higher precision pathway should be used, there may still be a further selection between pathways based on the size of the input argument, which may not generally be known in advance. Thus, the higher precision pathway shader program may, and in an embodiment does, still include one or more conditional instructions to allow the program to branch depending on the size of the input exponent.

Various arrangements would be possible in this regard.

The effect of all this is therefore to provide a more efficient algorithm for evaluating transcendental trigonometric functions using a graphics processor that is configured to perform floating point arithmetic. This then provides a more efficient graphics processor operation. That is, the novel range reduction operation described above may find particular utility when implemented by a graphics processor as the algorithm is particularly designed to optimise the graphics processor operation when evaluating such transcendental trigonometric functions, in particular by allowing such functions to be evaluated using relatively fewer instructions (processing cycles).

However, the present Applicants recognise that the novel range reduction described above may also find more general utility for evaluating transcendental trigonometric functions in floating point arithmetic.

Thus, a further embodiment of the technology described herein comprises a method (in an embodiment computer-implemented) of evaluating a sinusoidal or cosinusoidal trigonometric function to a first precision for a particular input argument x, wherein the input argument x is defined in a first floating point format having an exponent E and a p-bit mantissa, the method comprising:
evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the product of the input argument x and R,
wherein R is an approximation to m/pi, with m being a rational number, and wherein the value for R is obtained as a sum of terms, R0+R1+ . . . , each term in the sum of terms being smaller compared to the previous term, the product of the input argument x and R thus being determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the x.R0−z can be evaluated by a sequence of one or more arithmetic operations in floating point without any floating point rounding error.

As will be appreciated by those skilled in the art, the methods according to this additional embodiment of the technology described herein can, and in an embodiment do, include any one or more or all of the features of the technology described herein relating to the operation of the graphics processor described herein according to the first and second embodiments presented above, as appropriate.

Thus, the methods according to these additional embodiments of the technology described herein are in an embodiment executed by a graphics processor (but need not be).

Subject to the requirements of the technology described herein the graphics processor may otherwise be operated, and configured, in any suitable and desired manner, e.g. in the normal manner for a graphics processor.

In some embodiments, the graphics processor comprises, and/or is in communication with, one or more memories and/or memory devices that store the data described herein, and/or store software for performing the processes described herein. The graphics processor may also be in communication with a host microprocessor, and/or with a display for displaying images based on the data generated by the data, e.g. graphics, processor.

As well as the floating point arithmetic units, there may also be other accelerators (special purpose units) that are able to communicate with the programmable execution unit, such as a load/store unit (circuit), a texture mapper, etc., if desired.

The graphics processor may comprise a single programmable execution unit, or may have plural programmable execution units. Where there are a plural programmable execution units, each programmable execution unit can, and in an embodiment does, operate in the manner of the technology described herein. Where there are plural programmable execution units, each programmable execution unit may be provided as a separate circuit to other programmable execution units of the data processor, or the programmable execution units may share some or all of their circuits (circuit elements).

The (and each) programmable execution unit should, and in an embodiment does, comprise appropriate circuits (processing circuits/logic) for performing the operations required of the programmable execution unit.

As is often the case for graphics processors, the programmable execution unit in the technology described herein is in an embodiment operable to execute programs for groups of plural threads together (which execution thread groups are often referred to as “warps”, and the terms “warp” and “execution thread group” may both be used in the present application to refer to such groups of threads that are executed together), e.g. in lockstep, e.g., one instruction at a time, e.g. in a single instruction, multiple thread (SIMT) execution state.

When executing an instruction in a program, the programmable execution unit (e.g. the appropriate functional unit, such as an arithmetic unit, of the programmable execution unit) will typically read one or more input data values (operands), perform a processing operation using those input data values to generate an output data value, and then return the output data value, e.g. for further processing by subsequent instructions in the program being executed and/or for output (for use otherwise than during execution of the program being executed). The input data values to be used when executing the instruction will typically be stored “locally” in an appropriate set of registers (a register file) of and/or accessible to the execution (functional) unit, and the output data value(s) generated by the execution (functional) unit when executing the instruction will correspondingly be written back to that storage (register file).

To facilitate this operation, each execution thread, when executing a shader program, will correspondingly be allocated a set of one or more registers for use by that thread when executing the shader program. Thus when executing an instruction, an execution thread will read input data values (operands) from a register or registers of a set of one or more registers allocated to that thread, and write its output value(s) back to a register or registers of the thread's register allocation. The data will be loaded into the registers, and written out from the registers, from and to an appropriate memory system of or accessible to the graphics processor (e.g. via an appropriate cache system (cache hierarchy)).)

Thus, as well as the programmable execution unit, the graphics processor includes a group of plural registers (a register file) operable to and to be used to store data for execution threads that are executing. Each thread of a group of one or more execution threads that are executing a shader program will have an associated set of registers to be used for storing data for the execution thread (either input data to be processed for the execution thread or output data generated by the execution thread) allocated to it from the overall group of registers (register file) that is available to the programmable execution unit (and to execution threads that the programmable execution unit is executing).

The group(s) of registers (register file(s)) can take any suitable and desired form and be arranged in any suitable and desired manner, e.g., as comprising single or plural banks, etc.

The graphics processor will correspondingly comprise appropriate load/store units and communication paths for transferring data between the registers/register file and a memory system of or accessible to the graphics processor (e.g., and in an embodiment, via an appropriate cache hierarchy).

Thus the graphics processor in an embodiment has an appropriate interface to, and communication with memory (a memory system) of or accessible to the graphics processor.

The memory and memory system is in an embodiment a main memory of or available to the graphics processor, such as a memory that is dedicated to the graphics processor, or a main memory of a data processing system that the graphics processor is part of. In an embodiment, the memory system includes an appropriate cache hierarchy intermediate the main memory of the memory system and the programmable execution unit(s) of the graphics processor.

In an embodiment, the graphics processor is part of an overall data processing system that comprises one or more memories and/or memory devices and a host processor (and, optionally, a display). In an embodiment, the host microprocessor is operable to execute applications that require data, e.g. graphics, processing by the graphics processor, with the graphics processor operating when required to perform processing for applications executing on the host processor.

Other arrangements would, of course, be possible.

The technology described herein can be used for all forms of output that a graphics processor (and processing pipeline) may be used to generate. For instance, in the case of graphics processing, the outputs may comprise frames (images) for display, render to texture outputs, etc. On the other hand, in the case where the graphics processor is used for more general-purpose “compute” operations, the output may more generally be a result of a set of calculations, for example. The output data values from the processing are in an embodiment exported to external, e.g. main, memory, for storage and use, such as to a frame buffer for a display in the case of graphics processing.

The technology described herein is applicable to any suitable form or configuration of graphics processor and data processing system. In an embodiment, the various functions of the technology described herein are carried out on a single data processing platform that generates and outputs data.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, unless otherwise indicated, the various functional elements, and stages of the technology described herein may comprise a suitable processor or processors, controller or controllers, functional units, circuits, circuitry, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits, etc., if desired.

Subject to any hardware necessary to carry out the specific functions discussed above, the data processing system and graphics processor can otherwise include any one or more or all of the usual functional units, etc., that data processing systems and graphics processors include.

It will also be appreciated by those skilled in the art that all of the described embodiments of the technology described herein can, and in an embodiment do, include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a processor, renderer or microprocessor system comprising data processor causes in conjunction with said data processor said processor, renderer or microprocessor system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

The present technique will be described, by way of example only, with reference to embodiments thereof as illustrated in the accompanying drawings.

The drawings show elements of a data processing apparatus and system that are relevant to embodiments of the technology described herein. As will be appreciated by those skilled in the art there may be other elements of the data processing apparatus and system that are not illustrated in the drawings. It should also be noted here that the drawings are only schematic, and that, for example, in practice the shown elements may share significant hardware circuits, even though they are shown schematically as separate elements in the drawings. Like reference signs are used in the figures to denote like elements or units.

A number of embodiments of the technology described herein will now be described in the context of the processing of computer graphics for display by a graphics processor. However, it will be appreciated that the techniques described herein can be used in other non-graphics contexts.

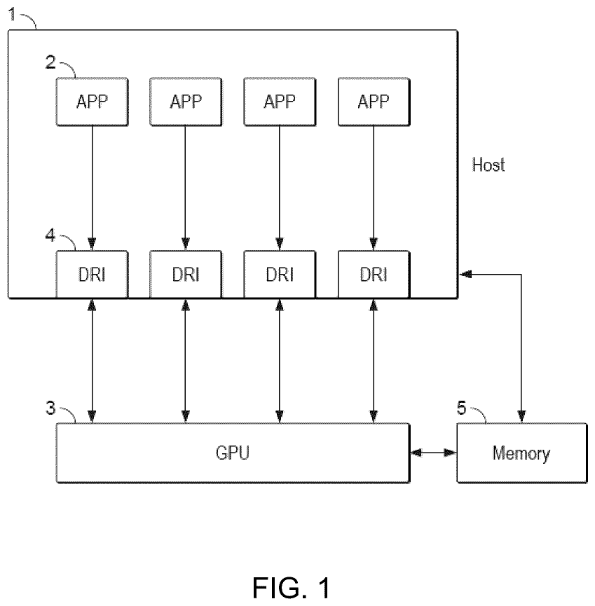

FIG. 1 shows an exemplary computer graphics processing system. An application 2, such as a game, executing on a host processor (CPU) 1 will require graphics processing operations to be performed by an associated graphics processing unit (GPU) (graphics processor) 3 that executes a graphics processing pipeline. To do this, the application will generate API (Application Programming Interface) calls that are interpreted by a driver 4 for the graphics processor 3 that is running on the host processor 1 to generate appropriate commands to the graphics processor 3 to generate graphics output required by the application 2. To facilitate this, a set of “commands” will be provided to the graphics processor 3 in response to commands from the application 2 running on the host system 1 for graphics output (e.g. to generate a frame to be displayed).

As shown in FIG. 1, the graphics processing system will also include an appropriate memory system 5 for use by the host CPU 1 and graphics processor 3.

When a computer graphics image is to be displayed, it is usually first defined as a series of primitives (polygons), which primitives are then divided (rasterised) into respective sets of one or more graphics fragments (fragment work items) for graphics rendering in turn. During a normal graphics rendering operation, the renderer will modify the (e.g.) colour (red, green and blue, RGB) and transparency (alpha, a) data associated with each set of fragments so that the fragments can be displayed correctly. Once the fragment work items have fully traversed the renderer, their associated data values are then stored in memory, ready for output, e.g. for display.

In the present embodiments, graphics processing is carried out in a pipelined fashion, with one or more pipeline stages operating on the data to generate the final render output, e.g. frame that is displayed.

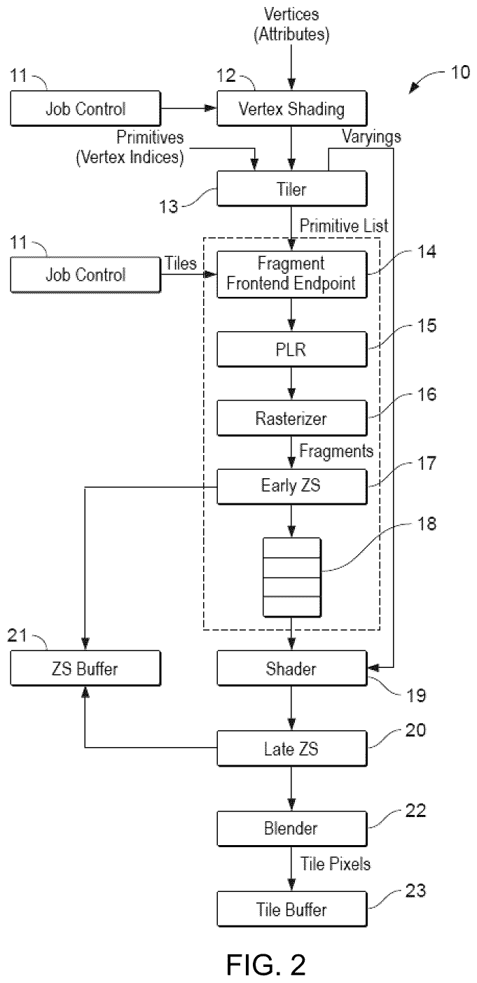

FIG. 2 shows an exemplary graphics processing pipeline 10 that may be executed by a graphics processor. The graphics processing pipeline 10 shown in FIG. 2 is a tile-based system, and will thus produce tiles of a render output data array, such as an output frame to be generated. (The technology described herein is however also applicable to other systems, such as immediate mode rendering systems.) The output data array may typically be an output frame intended for display on a display device, such as a screen or printer, but may also, for example, comprise a “render to texture” output of the graphics processor, or other suitable arrangement.

FIG. 2 shows the main elements and pipeline stages of a graphics processing pipeline that may be operated according to embodiments of the technology described herein. As will be appreciated by those skilled in the art, there may be other elements of the graphics processing pipeline that are not illustrated in FIG. 2. It should also be noted here that FIG. 2 is only schematic, and that, for example, in practice the shown functional units and pipeline stages may share significant hardware circuits, even though they are shown schematically as separate stages in FIG. 2. Equally, some of the elements depicted in FIG. 2 need not be provided, and FIG. 2 merely shows one example of a graphics processing pipeline 10. It will also be appreciated that each of the stages, elements and units, etc., of the graphics processing pipeline as shown in FIG. 2 may be implemented as desired and will accordingly comprise, e.g., appropriate circuits and/or processing logic, etc., for performing the necessary operation and functions.

The graphics processing pipeline as illustrated in FIG. 2 will be executed on and implemented by an appropriate graphics processing unit (GPU) (graphics processor) that includes the necessary functional units, processing circuits, etc., operable to execute the graphics processing pipeline stages.

In order to control a graphics processor that is implementing a graphics processing pipeline to perform the desired graphics processing operations, the graphics processor will typically receive commands and data from a driver, e.g. executing on a host processor, that indicates to the graphics processor the operations that it is to carry out and the data to be used for those operations.

As shown in FIG. 2, for an output to be generated, a set of vertices (with each vertex having one or more attributes, such as positions, colours, etc., associated with it) is provided to a vertex shading unit 12. A job controller 11 then causes the vertex shading unit 12 to process the input vertices, e.g. to transform the positions for the vertices from the, e.g. “world” space in which they are initially defined, to the, e.g. “screen”, space that the output image is being generated in.

The graphics processor includes a tiler 13 for preparing primitive lists. The tiler in effect determines which primitives need to be processed for different regions of the render output. In the present embodiments, these regions may, e.g., represent a tile into which the overall render output has been divided into for processing purposes, or a set of multiple such tiles.

To do this, the tiler 13 receives the shaded vertices, as well as a set of indices referencing the vertices in the set of vertices, and primitive configuration information indicating how the vertex indices are to be assembled into primitives for processing when generating the output, and then compares the location of each primitive to be processed with the positions of the regions, and adds the primitive to a respective primitive list for each region that it determines the primitive could (potentially) fall within. Any suitable and desired technique for sorting and binning primitives into primitive lists, such as exact binning, or bounding box binning or anything in between, can be used for the tiling process.

The tiler 13 thus performs the process of “tiling” to allocate the assembled primitives to primitive lists for respective render output regions (areas) which are then used to identify the primitives that should be rendered for each tile that is to be rendered to generate the output data (which may, e.g. be a frame to be rendered for display). For example, the tiler 13 may be implemented using a primitive list building unit which takes the assembled primitives as its input, builds primitive lists using that data, and stores the primitive lists in memory.

Once the tiler 13 has completed the preparation of the primitive lists (lists of primitives to be processed for each region), then each tile can be rendered with reference to its associated primitive list(s).

To do this, each tile is processed by the graphics processing pipeline stages shown in FIG. 2.

The job controller 11 issues tiles to a “fragment” frontend endpoint 14 that receives the tile to be processed and the primitive lists, which are then passed to a primitive list reader 15 (PLR) that determines which primitives need to be rendered for the tile in question.

A rasterisation stage (circuit) (rasteriser) 16 then takes as its input the primitives (including their vertices), from the primitive list(s) for the tile being rendered, rasterises the primitive to fragment work items, and provides the fragment work items to a fragment processing stage (circuit) 19, which in this embodiment comprises a shader execution engine (a shader core). The shader execution engine is a programmable execution unit that performs fragment shading by executing fragment shading software routines (programs) for fragments received from the rasteriser 16.

In this example the fragment work items generated by the rasteriser 16 are subject to (early) depth (Z)/stencil testing 17, to see if any fragment work items can be discarded (culled) at this stage. To do this, the Z/stencil testing stage 17 compares the depth values of (associated with) fragment work items issuing from the rasteriser 16 with the depth values of fragment work items that have already been rendered (these depth values are stored in a depth (Z)/stencil buffer 21) to determine whether the new fragment work items will be occluded by fragment work items that have already been rendered (or not). At the same time, an early stencil test is carried out.

Fragment work items that pass the fragment early Z and stencil test stage 17 may then be used for various further culling operations, as desired, before the remaining fragment work items are then passed to a fragment shading stage for rendering.

The fragment work items that survive the primitive processing are then queued 18 for input to the fragment processing stage (circuit) 19 (the fragment shader).

Each fragment work item will be processed by means of one or more execution threads which will execute the instructions of the shader program in question for the fragment work item in question. Typically, there will be multiple execution threads each executing at the same time (in parallel).

Other vertex attributes (varyings), such as colours, transparency, etc., that are needed will be fetched (and as necessary “vertex shaded”) as part of the fragment shading processing.

After the fragment shading is performed, a late depth/stencil text 20 may then be performed.

After this, the output of the fragment processing (the rendered fragment work items) is then subject to any desired post-processing, such as blending (in blender 22), and then written out to a tile buffer 23. Once the processing for the tile in question has been completed, then the tile will be written to an output data array in memory, and the next tile processed, and so on, until the complete output data array has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), etc.

Other arrangements would of course be possible.

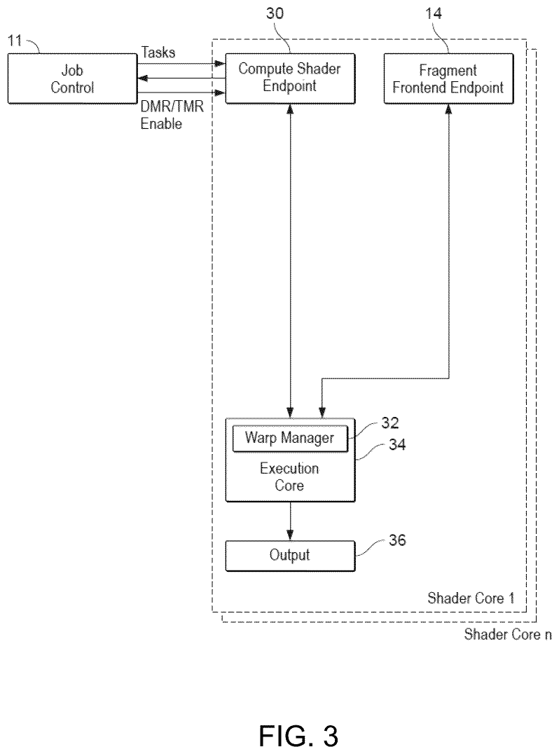

FIG. 3 shows schematically some of the relevant functional units for an execution unit (shader core) of a graphics processor according to an embodiment.

As discussed above, there is an overall job controller 11 that is operable to schedule processing tasks to be performed by the execution unit (shader core). In the example shown in FIG. 3, the execution unit comprises a plurality of shader cores (shader core 1, shader core n) that are arranged in parallel and the job controller 11 is operable to schedule processing tasks for each of the shader cores.

Other arrangements would of course be possible.

In particular, FIG. 3 shows an example of a fragment shader (e.g. fragment processing stage 19 in the graphics processing pipeline 10 in FIG. 2) and the job controller 11 is therefore operable to schedule fragment processing tasks for a respective shader core, which processing tasks are then handled by a respective fragment frontend endpoint 14 for the shader core.

As shown in FIG. 3, the unit also comprises a compute shader endpoint 30 that is operable to handle compute shader tasks. These are handled in a similar manner as described above, by the job controller 11 issuing tasks to the compute shader endpoint 30 for processing work items, but wherein the work items do not correspond to fragments, but instead correspond to data instances (items) in the work “space” that the compute shading operation is being performed on.

The job controller 11 thus issues processing tasks to the relevant shader endpoint which then causes the warp manager 32 to generate an appropriate group of execution threads for processing the work items that are required to be processed for the processing task in question.

The generated group of execution threads are scheduled for execution by the execution core 34 accordingly, and then executed, in order to perform the desired processing for the work items. The result of the processing for the work item is in turn provided to a suitable output stage 36 of the shader core (e.g. such that it may be used by subsequent stages of the graphics processing pipeline 10 for continuing the overall graphics processing (e.g. rendering) operation that is being performed).

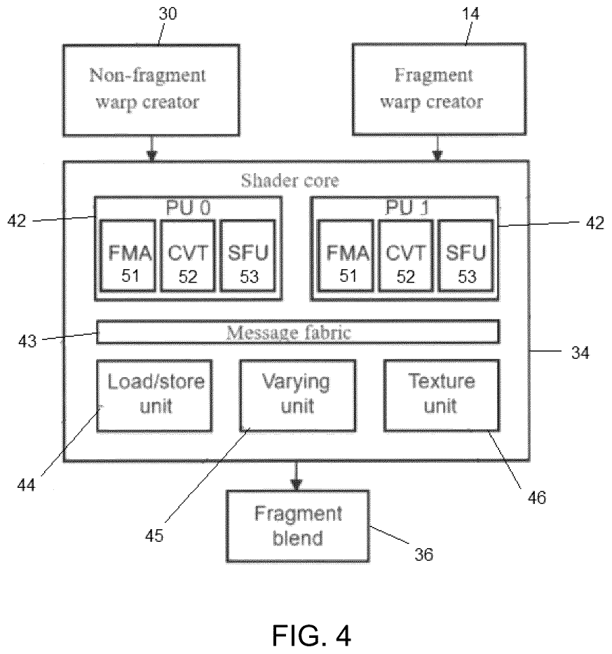

FIG. 4 shows further details of a graphics processor execution core 34 (which may function as the vertex shading stage 12, the fragment shading stage 19 or as a compute shader core, or as any other form of shader core, as required) in more detail. FIG. 4 shows in particular the operational units of the shader core of the graphics processor that are relevant to the operation of the technology described herein. (As will be appreciated by those skilled in the art, the execution core 34 may include other elements, components, etc., not shown in FIG. 4.

Figure simply illustrates some of the elements and components, etc., of the shader core that are relevant to the operation of the present embodiments.) As shown in FIG. 4, and as described also in relation to FIG. 3, the execution core 34 is able to receive both fragment and non-fragment (i.e. compute) tasks.

In the execution core 34 shown in FIG. 4 there are two parallel processing engines providing (PU0, PU1), each containing their own respective set of arithmetic units. In particular, in this example, each processing engine has access to a set of arithmetic units including a fused-multiply-accumulate (FMA) unit that is configured to implement floating point multipliers, a convert unit (CVT) that is configured to implement relatively simpler operations, such as format conversion and/or integer addition, and a special functions unit (SFU) that is configured to implement a special functions unit for computation of more complex functions.

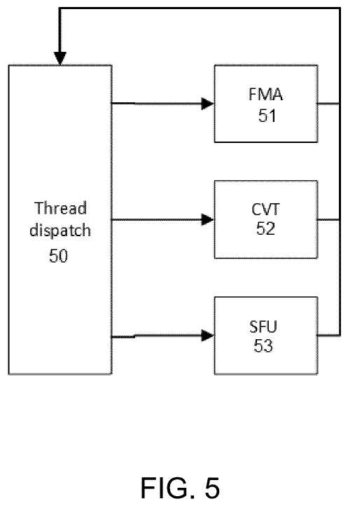

FIG. 5 shows the operation of a processing engine in more detail where a suitable thread dispatch circuit is operable to cause the various arithmetic units to perform respective operations in response to suitable instructions in the shader program being executed

In the example shown in FIG. 4, the shader core also comprises a texture unit that is configured to handle all texture sampling and filtering operation, a load/store unit that is configured to handle all non-texture memory accesses and a varying unit that is a dedicated pipeline for implementing the varying interpolator.

A suitable message fabric is also provided to allow the processing engines to appropriately message such units.

It is often the case when executing a given shader program to perform data processing that the shader program may require evaluation of a transcendental trigonometric function. This may be required as part of a particular graphics processing task but is also commonly the case when the graphics processor is being used to perform more general purpose, “compute”, work (e.g. for scientific computing).

It is also often the case that the transcendental trigonometric function may need to be evaluated for an arbitrarily large input argument. Thus, such functions are typically evaluated by first performing a suitable range reduction to reduce the input argument into a reduced range in which the trigonometric function is to be evaluated.

Range reduction for sine and cosine functions is generally based on the following equation:

$$u = x - k C \qquad Equation l$$

where C is pi/2 and k is an integer chosen so that the reduced argument, u, falls within the range [−pi/4, pi/4] within which the sine/cosine function can be evaluated using a suitable table-based polynomial approximation. The evaluation of the sine/cosine function within the reduced range can generally be done in any suitable and desired manner, e.g. in the normal manner for evaluating such functions. For instance, in embodiments, this can be done using a dedicated instruction such as an FSINCOS instruction that when executed causes the special function unit (SFU) to evaluate the sine and cosine functions using appropriate polynomial approximations to those functions.

Although the range reduction operation is conceptually simple, it can be difficult to do in floating point arithmetic without losing precision.

Depending on the desired precision requirements, different approaches may therefore be used for the range reduction operation. For example, for graphics processing, the precision requirements specified by the Vulkan/DX API are relatively relaxed. On the other hand, for compute work, the precision requirements specified by OpenCL is much more strict, and therefore more advanced approaches are needed.

In the present embodiments, as will be explained further below, the graphics processor is thus operable to select between a plurality of different range reduction operations depending on the desired level of precision.

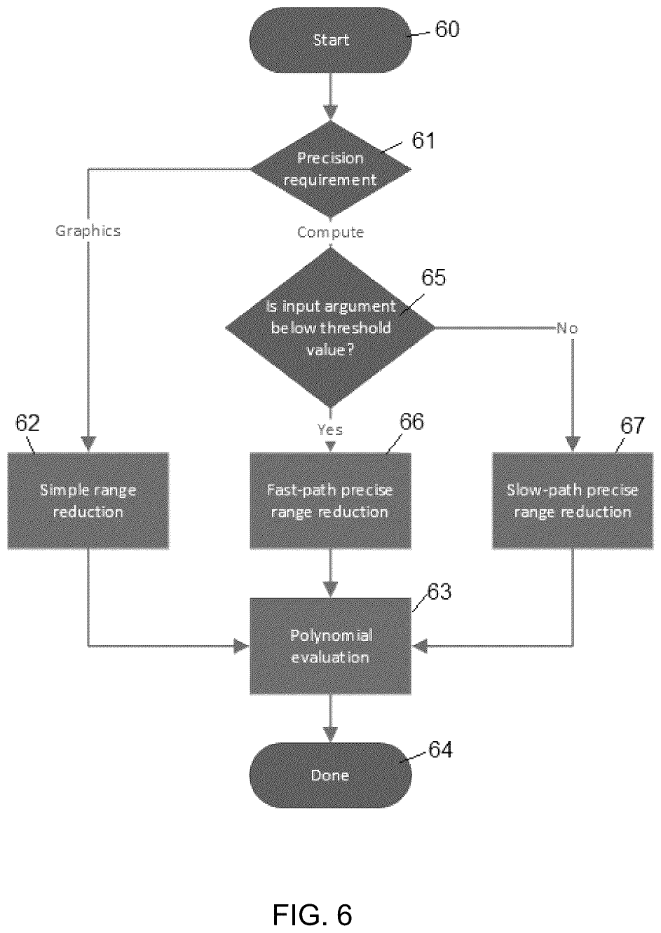

Thus, as shown in FIG. 6, when a program requires evaluation of a trigonometric function for a particular input arguments (step 60), it is initially determined the level of precision at which it is desired (e.g. as mandated by the API requirements) to evaluate the trigonometric function (step 61). For applications where a lower (graphics) level of precision is acceptable (step 61—‘graphics’), a relatively simpler range reduction operation can thus be (and is) selected (step 62).

On the other hand, for applications where a higher (compute) level of precision is acceptable (step 61—‘compute’), the algorithm may then proceed down the compute pathway. In the present embodiments, the graphics processor is further operable to, and configured to, implement two different compute pathways, namely a ‘fast’ compute path and a ‘slow’ compute path, that implement different respective range reduction operations, and that can be selected between based on the size of the input argument (step 65). Thus, so long as the input argument is below a certain threshold value (step 65—yes), the ‘fast’ compute path can be (and is) used (step 66), wherein the range reduction operation that is implemented by the ‘fast’ compute pathway is sufficient to provide the desired compute precision at least for smaller input arguments. However, for larger input arguments (step 65—no), the ‘slow’ compute path is required to be used to provide the desired compute precision, and so this path is accordingly selected (step 67).

It will be appreciated that the selection illustrated in FIG. 6 may be performed by the graphics processor during shader program execution. That is, the shader program may include one or more conditional instructions that allow the program execution to branch to the desired path depending on the precision requirement and/or size of the input argument. However, it would also be possible for at least some of the selection to be performed, e.g., by the driver for the graphics processor. For example, the initial selection between the graphics pathway and the compute pathways (at step 61) may be made by the driver according to the application requirements. The selection between the ‘fast’ and ‘slow’ compute pathways could in some cases also be made by the driver so long as the input argument is known. However, in general, the input argument may not be known until execution time. Therefore, in some embodiments, at least the selection between the ‘fast’ and ‘slow’ compute pathways is performed by the graphics processor with an appropriate instruction provided that processes the input argument to determine whether or not it is below the desired threshold value and then branches appropriately to the ‘fast’ or ‘slow’ compute pathway based on this determination.

That is, the compiler can determine at compile-time whether it is compiling a graphics shader program or a compute kernel, for example, and can thus select between the available graphics and compute pathways. However, as the input argument may generally not be known at compile time, the compute kernel may therefore, and typically will, contain an appropriate set of conditional operations to select between the ‘fast’ and ‘slow’ compute pathways. For example, an implementation in pseudocode would be:

If(|x| < 2²²)
{
runFast(x);
}
Else
{
runSlow(x)
}

where runFast(x) causes the compute kernel to execute the fast compute pathway whereas runSlow(x) causes the compute kernel to execute the slow compute pathway.

Thus, for graphics processing, where the API may allow for relatively lower precision requirements, a relatively simpler range reduction may be performed (e.g. according to the ‘graphics pathway’ discussed below). Once the range reduction is performed, the trigonometric function is then evaluated for the reduced input argument using a suitable polynomial approximation.

On the other hand, when performing “compute” operations, the API may mandate relatively higher precision requirements. According to the present embodiment, it is then further checked whether the input argument is below a certain threshold value. For relatively smaller input arguments (below the threshold), the ‘fast’ compute pathway discussed below can suitably be used, as this will provide the desired level of precision. However, for relatively larger input arguments (above the threshold), the ‘slow’ compute pathway of the technology described herein is instead used in order to ensure the desired level of precision.

Thus, the present embodiment provides an overall improvement in that precision is ensured but the ‘slow’ compute pathway is only used when necessary, such that when there is a lower precision requirement, or when the input argument is sufficiently small that the ‘fast’ compute pathway is sufficiently precise, the other pathways can be used.

The range reduction operations according to the three different pathways are outlined in further detail below. In this discussion, the following lemmas may be useful.

### Lemma 1.1:

The basic subtraction theorem is Sterbenz lemma, as follows. Let x and y be p-digit floating point numbers. If y/2≤x≤2y, then x−y is a p-digit floating point number, i.e. the subtraction is exact and does not introduce any rounding error. This is valid for any integer radix β≥2 and any precision p≥2.

### Lemma 1.2:

There is also an extended version of Sterbenz lemma (see S. Boldo, M. Daumas, and R.-C. Li, “Formally verified argument reduction with a fused-multiple-add”, IEEE Transactions on Computers, Institute of Electrical and Electronic Engineers, 2009, vol. 58, no. 8, pp. 1139-1145, 2007. arXiv:0708.3722) as follows. Again, let x and y be p₁-digit floating point numbers.

If:

$$\frac{y}{1 + {β}^{p 2 - p 1}} \leq x \leq ( 1 + {β}^{p 2 - p 1} ) y$$

then x-y is a p₂-digit floating point number. This is valid with any integer pi, p₂≥2 and any integer radix β≥2.

### Lemma 1.3:

In S. Boldo, M. Daumas, and R.-C. Li, “Formally verified argument reduction with a fused-multiple-add”, IEEE Transactions on Computers, Institute of Electrical and Electronic Engineers, 2009, vol. 58, no. 8, pp. 1139-1145, 2007. arXiv:0708.3722 there is also the following lemma useful for argument reductions.

Assume;
p>3
x is a p-bit floating point number
R is a positive normal p-bit floating point number
z=o(o(3·2^{p-N-2}+x·R)−3·2^{p-N-2})
   |z|≥2^{1-N}
   |xR|≤2^{p-N-2}−2^{-N}
2^{-N} is a floating point number
   then there exists an integer I satisfying 2≤I≤p−2 such that:
   |z^{2N}| is an I-bit integer greater than 2ⁱ⁻¹
   |xR−z|≤2^{-N-1}

Note here that the expression o(denotes a rounding of the bracketed value. In the present embodiments the rounding is performed as round-to-nearest, tie-to-even, unless otherwise noted.

### Graphics Pathway

For the graphics pathway, the range reduction operation comprises evaluating the following equation;

$$u = x - k C = C ( x R - z ) = x - z C \qquad Equation 2$$

where C=o(pi/2), R=o(1/C) and z is evaluated according to lemma 1.3 as set out above. In this case, the range reduction can be implemented with just a few instructions, with a suitable code listing as follows:
Z=FMA(x, R, P)
z=ADD(Z, −P)
u=FMA(z, −C, x)
y=FSINCOS(u, Z)
where:
R=0x3F22F983=o(2/pi)
P=0x4B400000=3·2²²
C=0x3FC90FDB=o(pi/2)

This naïve range reduction can thus be implemented relatively quickly but does not provide suitable precision for higher-precision (e.g. “compute”) requirements. Nonetheless, this may be (and in the present embodiments is) used for graphics processing applications (i.e. the ‘graphics’ pathway shown in FIG. 4).

### ‘Fast’ Compute Pathway

Following closely the algorithm described in S. Boldo, M. Daumas, and R.-C. Li, “Formally verified argument reduction with a fused-multiple-add”, IEEE Transactions on Computers, Institute of Electrical and Electronic Engineers, 2009, vol. 58, no. 8, pp. 1139-1145, 2007. arXiv:0708.3722, it is possible to implement an algorithm for evaluating sin(x) (or cos(x)) that is correct for input arguments |x|<2²² with an error of ≤2.5 units of least precision. This algorithm may thus be suitable for compute precision requirements, at least for relatively smaller input arguments (i.e. the ‘fast’ compute pathway shown in FIG. 4).

The algorithm for the ‘fast’ compute pathway is defined in three stages where the rounding error of each stage is controlled carefully.

In the first stage, the reduced argument, u, is given by:

$$u = x - n {C}_{1} \qquad Equation 3$$

where n is computed according to Lemma 1.3 above and C₁=oₚ₋₂(pi/2). Choosing this slightly less optimal rounding of pi/2 ensures that u does not have any rounding error.

The second stage is to introduce a second term so that the reduced argument becomes

$$v = {v}_{1} + {v}_{2} = u - n {C}_{2} \qquad Equation 4$$

where once again C₂ is chosen such that C˜C₁+C₂ to more than working precision (where C₂<<C₁) to ensure no rounding error is introduced.

The third stage is then to create an unevaluated sum v=v₁+w with 2p significant bits.

$$w \approx {v}_{2} - {nC}_{3} \qquad Equation 5$$

where C≈C₁+C₂+C₃ and C₃<<C₂<<C₁.

The mechanism for choosing the constants C₁, C₂ and C₃ is defined in S. Boldo, M. Daumas, and R.-C. Li, “Formally verified argument reduction with a fused-multiple-add”, IEEE Transactions on Computers, Institute of Electrical and Electronic Engineers, 2009, vol. 58, no. 8, pp. 1139-1145, 2007. arXiv:0708.3722, the content of which in its entirety is incorporated by reference.

An implementation in shader code may thus be as follows:

//First stage
N = FMA(|x|, 0x3F22F983, 0x4B400000)
n = ADD(N, 0xCB400000)
u = FMA(−n, 0x3FC90FDC, |x|)
//Second stage
v₁ = FMA(−n, 0xB42EEF48, u)
// f2s
k1 = ADD(n, 0xB42EEF48)
k2 = ADD(k1, −n)
k2 = ADD(0xB42EEF48, −k2)
// f2p
t1 = MUL(u, −k1)
t2 = FMA(u, −k1, −t1)
// Accumulating correction terms
m1 = ADD(t1, −v1)
m2 = ADD(m1, t2)
v2 = ADD(m2, −k2)
//Third stage
w = FMA(−n, 0xA967B968, v2)
y = ADD(v1, w)
y = FSINCOS(y, N)
t = AND(x, 0x80000000)
y = XOR(y, t)

where the Fast2Prod (“f2p”) and Fast2Sum (“f2s”) functions are defined by standard compensated arithmetic techniques and can be performed accordingly.

The implementation of this algorithm costs 14 FMA, 2 CVT and 1 SFU instruction.

Various other implementation would however be possible. For instance, the code listing presented above may be further optimised using various special instructions.

### ‘Slow’ Compute Pathway

However, for larger input arguments, the ‘fast’ compute pathway described above may not provide sufficient precision. Thus, according to the present embodiments, for larger input arguments (i.e. |x|≥2²²) the range reduction is performed as follows.

The novel ‘slow’ compute algorithm is based on a Payne-Hanek approach, as described in M. H. Payne and R. N. Hanek, “Radian reduction for trigonometric functions”, j-SIGNUM, vol. 18, pp 19-24, January 1983, and also used in K. C. Ng, “Argument reduction for huge arguments: Good to the last bit”, tech. rep., 1992, and further based on the realisation that for larger input arguments most digits in C are not being used. For instance, it can be recognised from the above that;

$$u = x - kC = C ( xR - k ) = Cfrac ( xR ) \qquad Equation 6$$

where R=1/C and frac( ) is the fractional part of the input argument. Re-writing this slightly gives

$$frac ( xR ) = frac ( M {2}^{E - p} R ) \qquad Equation 7$$

where M is a p-digit integer and E is the integer exponent. Grouping the second two factors gives 2^{E-p}R=I+F where I and F are the integer and fractional parts, respectively. Thus,

$$frac ( xR ) = frac ( M ( {I}_{+} F ) ) = frac ( MF ) \\ ( since frac ( MI ) = 0 ) . \qquad Equation 8$$

The interpretation of this is that with input arguments above the exponent p the top significant bits of R are inconsequential since they do not contribute to the fraction. Hence, the max(0, E-p) top bits of R can be dropped without loss of precision. This then means that significantly fewer bits need to be kept in the computation.

In general, range reduction for sine/cosine needs many significant bits to provide sufficient precision. Often, and in the present embodiment, an approximation is therefore done where R is defined as a sum of terms, R=R0+R1+ . . . , where each term is small compared to the previous term to simulate higher precision.

The present Applicants have recognised that it is possible to select the first term R0 in the sum of terms that is used to approximate R such that the product of x and the first term R0 (modulo 4) becomes exact with a single fused multiply-accumulate (FMA) instruction.

That is, the present Applicants have recognised that the following reduction can be performed exactly (without incurring any rounding error) with a single FMA instruction if R0=oₚ₋₂R, i.e. R rounded to p-2 bits, and z is chosen according to lemma 1.3 above:

$$u = xR 0 - z \qquad Equation 9$$

For instance, an FMA operation will use an internal wide precision to avoid any rounding between the multiply and the add. Thus, when R0 is a p−q bit floating point number and x is a p-bit floating point number, the internal intermediate result of the multiply is a 2p−q bit floating point number. Considering lemma 1.2 above it can be shown that u is then a p-bit floating point number, as follows;

### Lemma 2.1:

Using p₁=2p−q and p₂=p it can be proven that:

$$\frac{z}{1 + {2}^{q - p}} \leq xR \leq ( 1 + {2}^{q - p} ) z$$

The upper bound is

$$\frac{xR}{z} \leq 1 + {2}^{q - p}$$

and we get

$$\frac{xR}{z} = \frac{z + s}{z} = 1 + \frac{s}{z} \leq 1 + {2}^{- ℓ} \leq 1 + {2}^{2 - p} \leq 1 + {2}^{q - p}$$

where xR=z+s where z and s are the integer and fractional parts of the product xR, respectively. The above is obviously true for q≥2.
The lower bound is

$$\frac{z}{xR} \leq 1 + {2}^{q - p}$$

and we get

$$\frac{z}{xR} = \frac{z}{z + s} = 1 + \frac{s}{z + s} \leq 1 + \frac{s}{z} \leq 1 + {2}^{- ℓ} \leq 1 + {2}^{2 - p} \leq 1 + {2}^{q - p}$$

which again is true for q≥2. [symbol]
q=2 is thus a suitable choice for maximizing the number of bits of precision to be handled within the FMA operation.

This result can thus be used to build the ‘slow’ compute path for evaluating the reduced input argument according to;

$$u = \frac{π}{2} frac ( xR ) \qquad Equation 10$$

where R is defined according to lemma 2.1 above and can expressed as a sum of four terms, R=R0+R1+R2+r3 to more than working precision where;

R₁≤1ulp(R₀)

R₂≤1ulp(R₁)

R₃≤1ulp(R₂)

Following closely the ideas in K. C. Ng, “Argument reduction for huge arguments: Good to the last bit”, tech. rep., 1992, the following expression can be computed;

$$y = x ( R 0 + R 1 + R 2 + R 3 ) = o ( o ( o ( o ( x . R 3 ) + x . R 2 ) + x . R 1 ) + y 0 ) \qquad Equation 11$$

where y0=x.R0 modulo 4 according to lemma 2.1 above so that y0 fits into a single FP32 value without rounding error (with the product being evaluated modulo 4 in order to keep the result in a fixed range [0,4] which also helps in the subsequent polynomial evaluation as the FSINCOS instruction uses the integer part of the modulo 4 operation for quadrant selection in the polynomial evaluation).

The next step is to compute a compensation term to account for rounding errors in equation 11. This is done as follows;

$$t = o ( o ( o ( o ( y 0 - y ) + x \cdot R 1 ) + x \cdot R 2 ) + x \cdot R 3 ) \qquad Equation 12$$

noting that there is no need to accommodate for any rounding error for the first term x.R0 (since the value of R0 is selected such that there is no rounding error). After this, y is rounded to nearest integer using lemma 1.3 above, to give;

$$n = ⌈ y ⌋ = o ( o ( y + 3 \cdot {2}^{22} ) - 3 \cdot {2}^{22} ) \qquad Equation 13$$

The final reduced argument thus becomes;

$$u = pi / 2 ( ( y - n ) + t ) \qquad Equation 14$$

where the compensation term t is required to ensure the desired precision.

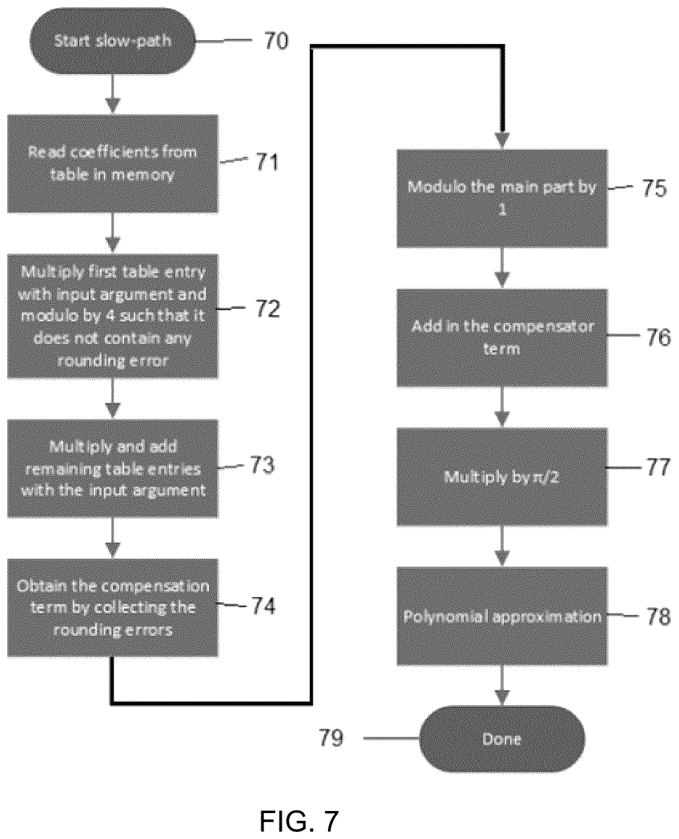

An implementation of the range reduction algorithm for the ‘slow’ compute pathway may thus comprise of the following steps, as shown in FIG. 7.

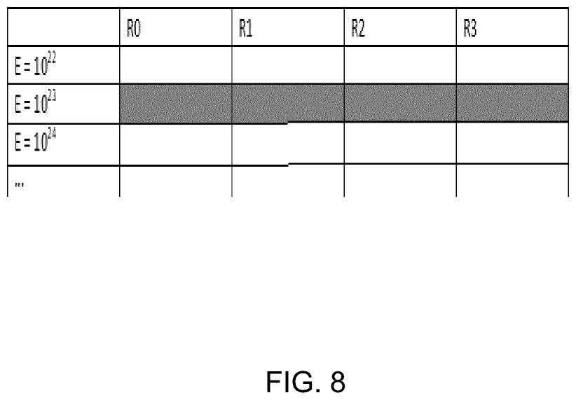

Thus, when the ‘slow’ compute path is selected, the coefficients (R0, R1, . . . ) are read from a table in memory. Due to equation 8 above the table entries are dependent on the input exponent. Hence, the table lookup uses the exponent as an index. Each table lookup comprises four FP32 entries which can be used to approximate R0+R1+R2+R3=2/pi (although with the top bits removed, as described above, in view of equation 8). This table lookup is shown schematically in FIG. 8. As shown in FIG. 8, the table is configured to store a plurality of different sets of R0, R1, R2, R3 values, with each set of R0, R1, R2, R3 values being configured for use with a different input argument exponent, e.g. by dropping the higher order bits that do not contribute to the final result. Thus, in the example shown in FIG. 8, for input argument exponent 10²³, the corresponding set of R0, R1, R2, R3 values are obtained and used for approximating R for the range reduction operation, as described herein.

In the present embodiment note that all table entries are scaled by 2²⁸ to avoid underflow for input arguments |x|≥2¹⁰⁰.

The input argument is then multiplied by the first table entry R0 and modulo by 4. As explained above, the first table entry R0 is carefully chosen according to lemma 2.1 so that it modulo by 4 fits exactly into a FP32 value without rounding error.

The input argument is then multiplied by the remaining table entries which are then added together to give x.R≈(R0+R1+R2+R3).x.

Note that in the present embodiment it is only the first term x.R0 that is evaluated modulo 4. This is because the values R1, R2 and R3 are configured such that the terms x.R1, x.R2 and x.R3 are much smaller than x.R0, such that these can effectively be considered as corrections, and typically will not change the order of magnitude of the x.R result. For example, typically, these additional terms will not take the x.R result outside of the range [0,4] within which the first term x.R0 is evaluated. At worst, these additional terms may take the x.R result only slightly outside of the range [0,4] but this does not lose precision as the subsequent modulo 1 operation (see below) will still evaluate the fractional part of the product x.R with good precision.

The compensation term t is then computed by collecting the rounding errors and the result x.R is then computed modulo 1 to remove the integer parts of this result and determine the fractional part. The compensation term t is then added and the result is then multiplied by pi/2 and shifted back to regular scale (2⁻²⁸) to give the final reduced argument u.

A polynomial approximation is then used to evaluate the function for the reduced input argument, correcting the sign as necessary. The polynomial approximation may be performed in any suitable and desired manner, e.g. in the manner in which this is normally done.

With a suitable polynomial approximation, the algorithm described above can then be used to evaluate sin(x) or cos(x) with precision of <3.5 units of least precision for input argument |x|≥2²², and is thus suitable for use as the ‘slow’ compute pathway described in relation to FIG. 4.

An implementation in shader code is as follows:

//Read table from memory
E = RSHIFT_AND(x, 23, 0x7f)
A0 = ADR(table)
A1 = MOV(pc.w1)
A1:A0 = SHADD(A1:A0, E, 4)
R3:R0 = LOAD.128(A1:A0)
//Multiply first term and mod by 4
Y0 = FMA(|x|, R0, 0x5A400000)
Y00 = ADD(Y0, 0xDA400000)
y0 = FMA(|x|, R0, −Y00)
//Multiply and add parts
y = MUL(|x|, R3)
y = FMA(|x|, R2, y)
y = FMA(|x|, R1, y)
y = ADD(y, y0)
//Compute compensation
t = ADD(y0, −y)
t = FMA(|x|, R1, t)
t = FMA(|x|, R2, t)
t = FMA(|x|, R3, t)
// Mod by 1
N = ADD(y, 0x59400000)
n = ADD(N, 0xD9400000)
y = ADD(y, −n)
//Compensate
y = ADD(y, t)
//Multiply by pi/2 * 2\hat{ }-28
y = MUL(y, 0x31C90FDB)
//Table lookup and polynomial approximation
y = FSINCOS(y, N)
//Sign correction
t = AND(x, 0x80000000)
y = XOR(y, t)

where the table coefficients R0, R1, R2, R3 are read from memory. This algorithm costs 16 FMA, 6 CVT and 1 SFU.

Thus, this is a significant improvement compared to other possible approaches. For example, compared to the implementation described in K. C. Ng, “Argument reduction for huge arguments: Good to the last bit”, tech. rep., 1992, the approach according to the technology described herein in which the table coefficients R0, R1, R2, R3 are configured to ensure that the product of the input argument x and the first term R0 modulo 4 can be evaluated without rounding error means that the number of compensation operations can be reduced. In contrast, the implementation described in K. C. Ng, “Argument reduction for huge arguments: Good to the last bit”, tech. rep., 1992, would require a much longer sequence of operations to handle the compensation terms.

The OpenCL precision requirement is 4 ULP for the entire FP32 input range. Thus, this can be achieved using the fast and slow compute paths described above. For instance, putting all of the above together gives an implementation having a total cost for the fast-path of 14 FMA+4 CVT+1 SFU and a total cost for the slow-path of 16 FMA+9 CVT+1 SFU+1 LOAD.

Accordingly, the present embodiment allows a more efficient graphics processor operation, in particular by optimising the range reduction algorithm for the graphics processor hardware, thus allowing desired precision to be obtained even for larger input arguments with relatively fewer processing cycles and without significant increase in area.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor comprising a programmable execution unit that is operable to execute programs to perform data processing, the programmable execution unit having access to a set of one or more floating point arithmetic units configured to perform floating point arithmetic operations, wherein the programmable execution unit when executing a program to perform data processing is operable in response to instructions in the program to cause the floating point arithmetic units to perform respective floating point arithmetic operations, the method comprising:
when executing a program to perform data processing that requires a sinusoidal or cosinusoidal trigonometric function to be evaluated to a first precision for a particular input argument x, wherein the input argument x is defined in a first floating point format having an exponent E and a p-bit mantissa:
the programmable execution unit executing a certain sequence of instructions for performing a corresponding sequence of processing operations for evaluating the trigonometric function to the first precision, the sequence of processing operations including one or more sequences of arithmetic operations to be performed using the set of floating point arithmetic units accessible by the programmable execution unit, the sequence of processing operations evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the fractional part of the product of the input argument x and R,
wherein R is an approximation to m/pi, with m being a rational number, and wherein the value for R is obtained as a sum of terms, R0+R1+ . . . , each term in the sum of terms being smaller compared to the previous term, such that the product of the input argument x and R can be determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the expression x.R0−z can be evaluated by a sequence of one or more arithmetic operations performed using the set of floating point arithmetic units accessible by the programmable execution unit without any floating point rounding error.

2. The method of claim 1, wherein the set of floating point arithmetic units includes at least one fused multiply-accumulate unit that is configured to perform a fused multiply-accumulate operation, and wherein the sequence of instructions for evaluating the trigonometric function includes a sub-sequence of instructions that perform the sequence of arithmetic operations for evaluating the expression x.R0 −z, wherein the sub-sequence of instructions for evaluating the expression x.R0−z includes a set of instructions for determining the value of z, and a further instruction to cause the fused multiply-accumulate unit to perform a respective fused multiply-accumulate operation that evaluates the expression x.R0−z using the determined value of z.

3. The method of claim 1, further comprising computing a compensation term t to account for the floating point rounding errors associated with computing the value for the product of the input argument x and R.

4. The method of claim 1, wherein the value of the first term, R0, in the sum of terms that is used to approximate the value for R is selected from a plurality of available values for the first term, R0, based on the input argument exponent E.

5. The method of claim 1, wherein the floating point arithmetic units are configured to perform operations using single-precision format floating point values, and wherein the value of the first term, R0, in the sum of terms that is used to approximate R is configured such that the product of the input argument x and the first term R0 can be fitted exactly into a single single-precision format floating point value.

6. The method of claim 1, wherein R is an approximation to 2/pi and wherein the range reduction is performed to reduce the input argument x into the range [−pi/4, pi/4].

7. The method of claim 1, wherein the graphics processor is operable to perform different range reduction operations depending on the desired precision, the method comprising an initial step of determining that the program to perform data processing that requires a sinusoidal or cosinusoidal trigonometric function to be evaluated to the first precision.

8. The method of claim 1, wherein the graphics processor when evaluating trigonometric functions to the first precision is operable to perform different range reduction operations depending on the size of the input argument, the method comprising determining that the input argument x is above a certain threshold size for the input argument.

9. A method of compiling a shader program to be executed by a programmable execution unit of a graphics processor that is operable to execute graphics processing programs to perform graphics processing operations;
the method comprising:
for a shader program to be executed by a programmable execution unit of a graphics processor, the programmable execution unit having access to a set of one or more floating point arithmetic units configured to perform floating point arithmetic operations, wherein the programmable execution unit when executing a program to perform data processing is operable in response to instructions in the program to cause the floating point arithmetic units to perform respective floating point arithmetic operations
including in the program a set of instructions to:
when the program to perform data processing that requires a sinusoidal or cosinusoidal trigonometric function to be evaluated to a first precision for a particular input argument x, wherein the input argument x is defined in a first floating point format having an exponent E and a p-bit mantissa:
cause the programmable execution unit to perform a corresponding sequence of processing operations for evaluating the trigonometric function to the first precision, the sequence of processing operations including one or more sequences of arithmetic operations to be performed using the set of floating point arithmetic units accessible by the programmable execution unit, the sequence of processing operations evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the product of the input argument x and R,
wherein R is an approximation to m/pi, with m being a rational number, and wherein the value for R is obtained as a sum of terms, R0+R1+ . . . , each term in the sum of terms being smaller compared to the previous term, such that the product of the input argument x and R can be determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation, and wherein the value of the first term, R0, in the sum of terms that is used to approximate the value for R is configured to ensure that the result of evaluating the expression x.R0−z can be fitted exactly into a single floating point value of the first floating point format such that the expression x.R0−z can be evaluated by a sequence of one or more arithmetic operations performed using the set of floating point arithmetic units accessible by the programmable execution unit without any floating point rounding error.

10. The method of claim 9, wherein the set of floating point arithmetic units includes at least one fused multiply-accumulate unit that is configured to perform a fused multiply-accumulate operation, and wherein the sequence of instructions for evaluating the trigonometric function includes a sub-sequence of instructions that perform the sequence of arithmetic operations for evaluating the expression x.R0 −z, wherein the sub-sequence of instructions for evaluating the expression x.R0−z includes a set of instructions for determining the value of z, and a further instruction to cause the fused multiply-accumulate unit to perform a respective fused multiply-accumulate operation that evaluates the expression x.R0−z using the determined value of z.

11. The method of claim 9, further comprising including in the program a set of instructions to compute a compensation term t to account for the floating point rounding errors associated with computing the value for the product of the input argument x and R.

12. The method of claim 9, wherein the graphics processor when evaluating trigonometric functions to the first precision is operable to perform different range reduction operations depending on the size of the input argument, the method further comprising including in the program a set of instructions to compare the input argument x with a certain threshold size for the input argument, wherein when the input argument x is below the certain threshold size, a different range reduction operation is performed.

13. A computer-implemented method of evaluating a sinusoidal or cosinusoidal trigonometric function to a first precision for a particular input argument x, wherein the input argument x is defined in a first floating point format having an exponent E and a p-bit mantissa, the method comprising:
evaluating the trigonometric function to the first precision by:
performing a range reduction operation to reduce the value of the input argument x into a reduced range of values within which the trigonometric function is to be evaluated; and
evaluating the trigonometric function for the reduced input argument;
wherein reducing the value of the input argument x into the desired range of values for evaluating the trigonometric function involves a step of computing a value for the product of the input argument x and R,
wherein R is an approximation to m/pi, with m being a rational number, and wherein the value for R is obtained as a sum of terms, R0+R1+ . . . , each term in the sum of terms being smaller compared to the previous term, the product of the input argument x and R thus being determined by adding the respective products of the input argument x and each respective term in the sum of terms, R0+R1+ . . . , that is used to obtain the value for R,
wherein the product of the input argument x and the first term, R0, in the sum of terms that is used to approximate the value for R is computed by evaluating the expression x.R0−z, where x.R0 is the product of the input argument x and the first term R0 and wherein z is selected to implement a modulo-by-4 operation,
and wherein the value of the first term, R0, in the sum of terms that is used to approximate the value for R is configured to ensure that the result of evaluating the expression x.R0−z can be fitted exactly into a single floating point value of the first floating point format such that the x.R0−z can be evaluated by a sequence of one or more arithmetic operations in floating point without any floating point rounding error.

14. The method of claim 13, further comprising computing a compensation term t to account for the floating point rounding errors associated with computing the value for the product of the input argument x and R.

15. The method of claim 13, wherein the value of the first term, R0, in the sum of terms that is used to approximate the value for R is selected from a plurality of available values for the first term, R0, based on the input argument exponent E.

16. The method of claim 13, wherein the graphics processor is operable to perform different range reduction operations depending on the desired precision, the method comprising an initial step of determining that the program to perform data processing that requires a sinusoidal or cosinusoidal trigonometric function to be evaluated to the first precision.

17. The method of claim 13, wherein the graphics processor when evaluating trigonometric functions to the first precision is operable to perform different range reduction operations depending on the size of the input argument, the method comprising determining that the input argument x is above a certain threshold size for the input argument.

18. A non-transitory computer program product comprising instructions that when executed by a processor perform a method as claimed in claim 1.
